(19) United States
(12) Patent Application Publication
(10) Pub. No.: US 2026/0270735 A1
(43) Pub. Date: Sep. 10, 2026

(54) SENSOR NETWORK CAPABILITY DETERMINATION

(71) Applicant: Lenovo (Singapore) Pte. Ltd., Singapore (SG)

(72) Inventors: Seyedomid Taghizadeh Motlagh, Oberursel (DE); Razvan-Andrei Stoica, Essen (DE); Ahmed Hindy, Aurora, IL (US)

(73) Assignee: Lenovo (Singapore) Pte. Ltd., Singapore (SG)

(21) Appl. No.: 19/152,882

(22) PCT Filed: Jan. 8, 2024
(86) PCT No.: PCT/IB2024/050172

§ 371 Date: Jul. 31, 2025

Related U.S. Application Data
(60) Provisional application No. 63/483,192, filed on Feb. 3, 2023.
(60) Provisional application No. 63/483,198, filed on Feb. 3, 2023.
(60) Provisional application No. 63/483,186, filed on Feb. 3, 2023.

(51) Int. Cl. H04W 24/08

(52) U.S. Cl. CPC H04W 24/08

(57) ABSTRACT

Various aspects of the present disclosure relate to sensor network capability determination. For instance, implementations provide a sensor network with configuration including multiple parts, such as a first configuration part that activates a subset of a set of sensing nodes and a second configuration part that configures the activated sensor nodes to compute one or more metrics corresponding to a sensing task over a sensed environment. Further, sensing nodes can collect sensing measurements and generate multi-part sensing reports based at least in part on the sensing measurements. Still further, a network can obtain sensing capability-related information of sensing nodes, including radio access technology (RAT)-dependent and RAT-independent sensing capabilities. The sensing configuration of the sensing nodes, for instance, can be determined based on collected sensing capabilities. The network can configure sensing nodes based at least in part on RAT-dependent and/or RAT-independent sensing capabilities of the sensing nodes.

### RELATED APPLICATIONS

This application claims priority to U.S. Provisional Application Ser. No. 63/483,186 filed Feb. 3, 2022, entitled “SENSOR NETWORK CONFIGURATION,” the disclosure of which is incorporated by reference herein in its entirety. This application also claims priority to U.S. Provisional Application Ser. No. 63/483,192 filed Feb. 3, 2022, entitled “SENSOR NETWORK REPORTING,” the disclosure of which is incorporated by reference herein in its entirety. This application also claims priority to U.S. Provisional Application Ser. No. 63/483,198 filed Feb. 3, 2022, entitled “SENSOR NETWORK CAPABILITY DETERMINATION,” the disclosure of which is incorporated by reference herein in its entirety.

### TECHNICAL FIELD

The present disclosure relates to wireless communications, and more specifically to sensing in wireless communication networks.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some wireless communications systems have proposed ways for environmental sensing, for as for detecting objects and object attributes within an environment. Current techniques for sensing in wireless communications, however, may be imprecise and may be limited in their ability to utilize sensing data across different technologies.

### SUMMARY

The present disclosure relates to methods, apparatuses, and systems that support sensor network capability determination. For instance, implementations provide a sensor network with configuration including multiple parts, such as a first configuration part that activates a subset of a set of sensing nodes and a second configuration part that configures the activated sensor nodes to compute one or more metrics corresponding to a sensing task over a sensed environment. Further, sensing nodes can collect sensing measurements and generate multi-part sensing reports based at least in part on the sensing measurements. Still further, a network can obtain sensing capability-related information of sensing nodes, including radio access technology (RAT)-dependent and RAT-independent sensing capabilities. The sensing configuration of the sensing nodes, for instance, can be determined based on collected sensing capabilities. The network can configure sensing nodes based at least in part on RAT-dependent and/or RAT-independent sensing capabilities of the sensing nodes.

By utilizing the described techniques, increased accuracy in wireless sensing can be achieved while reducing wireless overhead and/or usage of system resources.

Some implementations of the methods and apparatuses described herein may further include receiving, from one or more sensing nodes, sensing capability information including radio access technology (RAT)-dependent sensing capability information and RAT-independent sensing capability information; generating, based at least in part on the sensing capability information, configuration information including one or more of RAT-dependent sensing information or RAT-independent sensing information; and transmitting, to the one or more sensing nodes, the configuration information.

Some implementations of the methods and apparatuses described herein may further include: generating the configuration information to include an association of the one or more sensing nodes with at least one of one or more sensor groups or one or more logical sensors; wherein a sensor group of the one or more sensor groups corresponds to a logical sensor of the one or more logical sensors, and wherein a mapping of the one or more sensing nodes to the sensor group corresponds to a mapping of the one or more sensing nodes to logical sensor; wherein a mapping of the one or more sensor groups to the one or more sensing nodes is different than a mapping of the one or more logical sensors to the one or more sensing nodes; further including generating the configuration information to include one or more of a RAT-independent measurement request or a RAT-dependent sensing measurement type; further including transmitting, to at least one of the one or more sensing nodes or a sensor group associated with the one or more sensing nodes, a request for one or more of RAT-dependent sensing capability information or RAT-independent sensing capability information.

Some implementations of the methods and apparatuses described herein may further include: wherein the sensing capability information includes one or more of: a sensing activation latency; a sensing information refresh rate including a minimum time that one or more of a sensing measurement or sensing information is one or more of repeatable or refreshable; a sensing reporting latency; a type of supported or available RAT-independent sensing; a supported sensing information type via RAT-independent sensing; a type of supported or available RAT-dependent sensing; a supported sensing information type via RAT-dependent sensing; one or more of a supported sensing information resolution or a supported sensing information accuracy; one or more of a supported absolute area of sensing or a supported relative area of sensing; or a state of the one or more sensing nodes associated to a sensing capability; wherein the sensing capability information includes a first sensing capability for a first indicated sensing area and a second sensing capability for a second indicated sensing area.

Some implementations of the methods and apparatuses described herein may further include: wherein one or more of the first indicated sensing area or the second indicated sensing area includes at least one of an area of interest of sensing or an angular area for sensing; wherein a first sensing capability is indicated for a first sensing node state and a second sensing capability is indicated for a second sensing node state; wherein the sensing capability information is indicated via an index from a codebook, and wherein the codebook includes defined sensing capability characteristics of a sensing node; wherein the method is performed by a sensing management device that includes one or more of a user equipment (UE), a core network entity, a radio access network (RAN), a gNB, or a dedicated computation node; further including receiving, from the one or more sensing nodes, a sensing report including sensing measurements associated with one or more of the one or more sensing nodes or a sensing measurement type.

Some implementations of the methods and apparatuses described herein may further include: wherein the configuration information includes a measurement configuration for a RAT-dependent sensing measurement associated with the one or more sensing nodes, and the measurement configuration for the RAT-dependent sensing measurement includes one or more of an indication of sensing or a sensing information type; wherein the indication of the sensing information type includes an indication that a configured reference signal received power (RSRP) measurement of an indicated receive beam is intended for environment sensing for detection of an object blockage; further including receiving, from the one or more sensing nodes, an indication of non-RAT dependent sensing information related to configured RAT-dependent sensing measurement; wherein the indication of non-RAT dependent sensing information includes an indication that for one or more of a reference signal received power (RSRP) measurement of a beam directed at a given angle or a doppler measurement of a path, a RAT-independent sensing information is available.

Some implementations of the methods and apparatuses described herein may further include: wherein the RAT-independent sensing information includes an observation of one or more of an object blockage or a movement velocity via a camera at a same angle; further including receiving from the one or more sensing nodes an indication of a capability of obtaining a non-RAT dependent sensing information at the one or more sensing nodes related to the configured RAT dependent sensing measurement; further including receiving, from the one or more sensing nodes, an indication indicating that for the RSRP measurement for the beam directed at a given angle or a doppler measurement of a path, a RAT-independent sensing information is available upon network request following the capability information indicated by the one or more sensing nodes; further including receiving, from the one or more sensing nodes, one or more of a non-RAT dependent sensing information or a non-RAT dependent sensing measurement related to the measurement configuration.

Some implementations of the methods and apparatuses described herein may further include: receiving an indication from the one or more sensing nodes corresponding to a sensing technology utilized for a reported measurement; further including receiving a report indicating a blockage an angle detected based one or more of a WiFi signal or a camera; further including transmitting, to the one or more sensing nodes, a sensing information request, the sensing information request including: an indication of one or more types of sensing information; an indication of at least one of one or more types of RAT-dependent sensor technologies or one or more types of non-RAT dependent sensor technologies to be associated with the sensing information request; and timing information for the sensing information request; wherein the sensing information request is associated with a RAT-independent sensor technology at a sensor device and is based at least in part on the sensing capability information including radio access technology (RAT)-dependent sensing capability information and RAT-independent sensing capability information.

Some implementations of the methods and apparatuses described herein may further include transmitting, to a sensing management entity, sensing capability information including radio access technology (RAT)-dependent sensing capability information and RAT-independent sensing capability information; receiving, based at least in part on the sensing capability information, configuration information including RAT-dependent sensing information and RAT-independent sensing information; generating, based at least in part on the configuration information, one or more sensing measurements; and transmitting a sensing report including the one or more sensing measurements.

Some implementations of the methods and apparatuses described herein may further include: receiving a request for one or more of RAT-dependent sensing capability information or RAT-independent sensing capability information; and transmitting the sensing capability information based at least in part on the request; wherein the sensing capability information includes one or more of: a sensing activation latency; a sensing information refresh rate including a minimum time that one or more of a sensing measurement or sensing information is one or more of repeatable or refreshable; a sensing reporting latency; a type of supported or available RAT-independent sensing; a supported sensing information type via RAT-independent sensing; a type of supported or available RAT-dependent sensing; a supported sensing information type via RAT-dependent sensing; one or more of a supported sensing information resolution or a supported sensing information accuracy; one or more of a supported absolute area of sensing or a supported relative area of sensing; or a state of one or more sensing nodes associated with the sensing capability information.

Some implementations of the methods and apparatuses described herein may further include: wherein the sensing capability information includes a first sensing capability for a first indicated sensing area and a second sensing capability for a second indicated sensing area; wherein the sensing capability information is indicated via an index from a codebook, and wherein the codebook includes defined sensing capability characteristics of a sensing node; further including: receiving a request for one or more of RAT-dependent measurement configuration, including an indication for sensing and/or sensing information type; determining one or more of an availability or a capability to obtain a RAT-independent sensing information related to the received configuration of the RAT-dependent measurement; and transmitting an indication of the one or more of the availability or the capability of a RAT-independent sensing information related to the received configuration of the RAT-dependent measurement; wherein upon transmission of the capability information to obtain RAT independent sensing information, related to a RAT dependent measurement configuration, the method further includes: receiving a request for reporting the RAT independent sensing information; obtaining the requested RAT independent sensing information; and transmitting a report on the obtained RAT independent sensing information.

### BRIEF DESCRIPTION OF THE DRAWINGS

FIG. 1 illustrates an example of a wireless communications system that supports sensor network capability determination in accordance with aspects of the present disclosure.

FIG. 2 illustrates a scenario for aperiodic trigger state defining a list of CSI report settings.

FIG. 3 illustrates an information element for aperiodic trigger state indicating a resource set and QCL information.

FIG. 4 illustrates an information element for RRC configuration for NZP-CSI-RS/CSI-IM resources.

FIG. 5 illustrates a scenario for ordering for aperiodic CSI reporting.

FIG. 6 illustrates a scenario for a base station and UEs sensing target objects.

FIG. 7 illustrates a scenario for opaque and transparent sensing data.

FIG. 8 illustrates a scenario for UE-based sensing.

FIG. 9 illustrates example scenarios for radio sensing that support sensor network capability determination in accordance with aspects of the present disclosure.

FIG. 10 illustrates example scenarios for radio sensing that support sensor network capability determination in accordance with aspects of the present disclosure.

FIG. 11 illustrates a scenario that supports sensor network capability determination in accordance with aspects of the present disclosure.

FIGS. 12 and 13 illustrate examples of block diagrams of devices that support sensor network capability determination in accordance with aspects of the present disclosure.

FIGS. 14 through 21 illustrate flowcharts of methods that support sensor network capability determination in accordance with aspects of the present disclosure.

### DETAILED DESCRIPTION

Wireless communications systems have sought to improve data throughput and reliability throughout different cellular network generations. With new use cases and scenarios emerging that involve a massive number of wireless devices, as well as ultra-high data reliability, the use of current architectures may experience challenges due to limitations in channel knowledge, resource planning, and high-resolution tracking of the environment. For instance, the use of auxiliary sensor networks to assist conventional communication networks has been considered, such as for joint communication and sensing (JCS). In some wireless communications systems, proprietary signaling between 3GPP networks and a sensor network are utilized. For instance, communication between 3GPP networks and the sensor networks can be transparent to the 3GPP specification. This can result, however, in reduced network control of the configuration of the sensor network in addition to lack of sensor network interoperability with different network vendors.

Further, 3GPP network densification can occur. For instance, additional network nodes can be included in a 3GPP network within a given area, such that additional network nodes can perform similar role as that of the sensor network with reference-signal based sensing. However, the cost of expanding current networks via additional network nodes can be high due to the cost of adding network nodes with full functionality to current deployments. Moreover, using 3GPP-based network nodes for sensing can limit the sensing approach to reference-signal based implementations, which can be a restriction given that many sensor networks can be based on other (e.g., non-3GPP) technologies.

Accordingly, this disclosure provides for techniques that support sensor network capability determination. The described techniques, for instance, utilize a sensor network to provide high-resolution information of an environment including channel quality and/or distortion corresponding to different paths, channel condition with respect to whether a line-of-sight path is present between two sensing nodes, detection of blocking surfaces in the environment, and/or an estimate of a number of devices in a corresponding coverage area. For instance, implementations provide a network sensing configuration communicated via at least one network node with a sensor network including a group of sensing nodes.

For instance, in implementations a network configures a sensor network with configuration including multiple parts, such as a first configuration part that activates a subset of a set of sensing nodes, and a second configuration part that configures the activated sensor nodes corresponding to the subset of sensing nodes to compute one or more metrics corresponding to a sensing task over the sensed environment. The subset of sensing nodes can report an indication of the one or more metrics to the network node.

Further, sensing nodes can collect sensing measurements and generate multi-part sensing reports based at least in part on the sensing measurements. A sensing report, for instance, can include a first portion that identifies sensing nodes that collect sensing measurements used to generate the sensing report, a second portion that indicates a number of detected sensing events from which the sensing measurements were collected, and a third portion including sensing parameters reports. A network can utilize the sensing reports for various purposes, such as to determine physical and/or logical attributes of environments from which sensing measurements were collected.

Further, a network can obtain sensing capability-related information of sensing nodes, including RAT-dependent and RAT-independent sensing capabilities. The sensing configuration of the sensing nodes, for instance, can be determined based on the collected sensing capabilities. A network can configure a sensor network to group K sensing nodes into L logical sensors (e.g., where L≤K) and sensing nodes associated with a logical sensor share a same configuration as other sensing nodes associated with the logical sensor.

In implementations, a network transmits a set of beams to K sensing nodes and each sensing node sends, to the network, an indication of a beam index from a set of beam indices associated in a one-to-one fashion with the set of beams. Based on the received beam indices, the network can map each sensing node of the K sensing nodes with a distinct beam from the set of beams associated with the network node.

Thus, by utilizing the described techniques, increased accuracy in wireless sensing can be achieved while reducing wireless overhead and/or usage of system resources.

Aspects of the present disclosure are described in the context of a wireless communications system. Aspects of the present disclosure are further illustrated and described with reference to device diagrams and flowcharts.

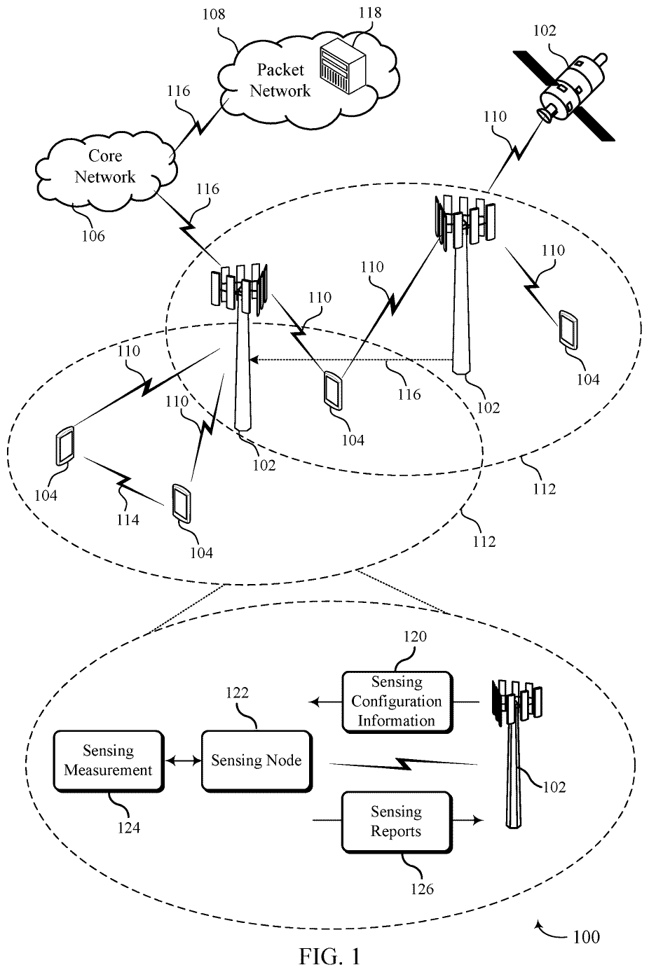

FIG. 1 illustrates an example of a wireless communications system 100 that supports sensor network capability determination in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a RAN, a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, V2X deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-real time (RT) RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., radio resource control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (e.g., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., u=0) may be associated with a first subcarrier spacing (e.g., 15 kHz) and a normal cyclic prefix. The first numerology (e.g., u=0) associated with the first subcarrier spacing (e.g., 15 kHz) may utilize one slot per subframe. A second numerology (e.g., u=1) may be associated with a second subcarrier spacing (e.g., 30 kHz) and a normal cyclic prefix. A third numerology (e.g., u=2) may be associated with a third subcarrier spacing (e.g., 60 kHz) and a normal cyclic prefix or an extended cyclic prefix. A fourth numerology (e.g., u-3) may be associated with a fourth subcarrier spacing (e.g., 120 kHz) and a normal cyclic prefix. A fifth numerology (e.g., u=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHZ), FR4 (52.6 GHZ-114.25 GHZ), FR4a or FR4-1 (52.6 GHZ-71 GHz), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations for sensor network capability determination, a network entity 102 transmits sensing configuration information 120 to a sensing node 122 to configure the sensing node 122 to perform various sensing tasks. In at least one implementation the network entity 102 represents and/or implements a sensing configuration entity and/or a sensing management entity. Examples of the sensing configuration information 120 are detailed throughout this disclosure. The sensing node 122 can be implemented in various ways, such as one or more of a UE 104, a dedicated sensing device, a network entity 102, a sensor group, a logical sensor, etc.

Accordingly, based at least in part on the sensing configuration information 120, the sensing node 122 performs sensing measurement 124. The sensing measurement 124 can include measuring various phenomena such as attributes of wireless signal detected at the sensing node 122 and/or other environmental attributes such as light sensing (e.g., light levels and/or images captured by the sensing node 122), motion data, temperature, and so forth. Based at least in part on the sensing measurement 124, the sensing node 122 generates sensing reports 126 and transmits the sensing reports 126 to the network entity 102. The sensing reports 126, for instance, include sensing measurements generated via the sensing measurement 124. In at least one implementation the sensing reports 126 are generated and/or formatted based on sensing report configuration indicated in the sensing configuration information 120.

In implementations, channel state information (CSI) codebooks can be defined as well as feedback for CSI-related bits. For instance, assume a gNB is equipped with a two-dimensional (2D) antenna array with N₁, N₂ antenna ports per polarization placed horizontally and vertically and communication occurs over N₃ PMI sub-bands. A PMI subband consists of a set of resource blocks, each resource block consisting of a set of subcarriers. In such cases, 2N₁N₂ CSI-Reference Signal (RS) ports can be utilized to enable downlink (DL) channel estimation with high resolution for NR Rel. 15 Type-II codebook. In order to reduce uplink feedback overhead, a Discrete Fourier transform (DFT)-based CSI compression of the spatial domain can be applied to L dimensions per polarization, where L<N₁N₂. In the sequel the indices of the 2L dimensions can be referred as the Spatial Domain (SD) basis indices. The amplitude and phase values of the linear combination coefficients for each sub-band can be fed back to the gNB as part of the CSI report. The 2N₁N₂×N₃ codebook per layer/can take on the form

$${W}_{l} = {W}_{1} {W}_{2 , l} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}}\end{matrix} ] ,$$

$${v}_{l , m} = {[ \begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}}\end{matrix} {u}_{m} ]}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation.

Note that O₁, O₂ oversampling factors can be assumed for the 2D DFT matrix from which matrix B is drawn. Note that W₁ can be common across all layers. W_{2,l} is a 2L×N₃ matrix, where the i^{th} column corresponds to the linear combination coefficients of the 2L beams in the i^{th} sub-band. The indices of the L selected columns of B can be reported, along with the oversampling index taking on O₁O₂ values. Note that W_{2,l} are independent for different layers.

For Type-II Port Selection codebook, K (where K≤2N₁N₂) beamformed CSI-RS ports can be utilized in DL transmission, in order to reduce complexity. The K×N₃ codebook matrix per layer can take the form

$${W}_{l} = {W}_{1}^{PS} {W}_{2 , l} .$$

Here, W₂ can follow the same structure as the conventional NR Rel. 15 Type-II Codebook and can be layer specific.

$${W}_{1}^{PS}$$

is a K×2L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix which columns can be standard unit vectors, such as follows.

$$E = [ \begin{matrix}{e}_{mod ( {m}_{PS} {d}_{PS} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )}\end{matrix} ] ,$$

where

$${e}_{i}^{( K )}$$

is a standard unit vector with a 1 at the i^{th} location. Here d_{PS} is an RRC parameter which takes on the values {1,2,3,4} under the condition d_{PS}≤min (K/2, L), whereas m_{PS} takes on the values

$$\{ 0 , … , ⌈ \frac{K}{2 {d}_{P S}} ⌉ - 1 \}$$

and is reported as part of the uplink CSI feedback overhead. W₁ can be common across all layers.

For K=16, L=4 and d_{PS}=1, the 8 possible realizations of E corresponding to m_{PS}={0,1, . . . , 7} are as follows

$$[ \begin{matrix}1 & 00 & 0 \\ 0 & 10 & 0 \\ 0 & 01 & 0 \\ 0 & 00 & 1 \\ 0 & 00 & 0 \\ 0 & 00 & 0 \\ 0 & 00 & 0 \\ 0 & 00 & 0\end{matrix} ] , [ \begin{matrix}0 & 00 & 0 \\ 1 & 00 & 0 \\ 0 & 10 & 0 \\ 0 & 01 & 0 \\ 0 & 00 & 1 \\ 0 & 00 & 0 \\ 0 & 00 & 0 \\ 0 & 00 & 0\end{matrix} ] , [ \begin{matrix}0 & 00 & 0 \\ 0 & 00 & 0 \\ 1 & 00 & 0 \\ 0 & 10 & 0 \\ 0 & 01 & 0 \\ 0 & 00 & 1 \\ 0 & 00 & 0 \\ 0 & 00 & 0\end{matrix} ] , [ \begin{matrix}0 & 00 & 0 \\ 0 & 00 & 0 \\ 0 & 00 & 0 \\ 1 & 00 & 0 \\ 0 & 10 & 0 \\ 0 & 01 & 0 \\ 0 & 00 & 1 \\ 0 & 00 & 0\end{matrix} ] , [ \begin{matrix}0 & 00 & 0 \\ 0 & 00 & 0 \\ 0 & 00 & 0 \\ 0 & 00 & 0 \\ 1 & 00 & 0 \\ 0 & 10 & 0 \\ 0 & 01 & 0 \\ 0 & 00 & 1\end{matrix} ] , [ \begin{matrix}0 & 00 & 1 \\ 0 & 00 & 0 \\ 0 & 00 & 0 \\ 0 & 00 & 0 \\ 0 & 00 & 0 \\ 1 & 00 & 0 \\ 0 & 10 & 0 \\ 0 & 01 & 0\end{matrix} ] , [ \begin{matrix}0 & 01 & 0 \\ 0 & 00 & 1 \\ 0 & 00 & 0 \\ 0 & 00 & 0 \\ 0 & 00 & 0 \\ 0 & 00 & 0 \\ 1 & 00 & 0 \\ 0 & 10 & 0\end{matrix} ] , [ \begin{matrix}0 & 10 & 0 \\ 0 & 01 & 0 \\ 0 & 00 & 1 \\ 0 & 00 & 0 \\ 0 & 00 & 0 \\ 0 & 00 & 0 \\ 0 & 00 & 0 \\ 1 & 00 & 0\end{matrix} ]$$

When d_{PS}=2, the 4 possible realizations of E corresponding to m_{PS}={0,1,2,3} are as follows

$$[ \begin{matrix}1 & 00 & 0 \\ 0 & 10 & 0 \\ 0 & 01 & 0 \\ 0 & 00 & 1 \\ 0 & 00 & 0 \\ 0 & 00 & 0 \\ 0 & 00 & 0 \\ 0 & 00 & 0\end{matrix} ] , [ \begin{matrix}0 & 00 & 0 \\ 0 & 00 & 0 \\ 1 & 00 & 0 \\ 0 & 10 & 0 \\ 0 & 01 & 0 \\ 0 & 00 & 1 \\ 0 & 00 & 0 \\ 0 & 00 & 0\end{matrix} ] , [ \begin{matrix}0 & 00 & 0 \\ 0 & 00 & 0 \\ 0 & 00 & 0 \\ 0 & 00 & 0 \\ 1 & 00 & 0 \\ 0 & 10 & 0 \\ 0 & 01 & 0 \\ 0 & 00 & 1\end{matrix} ] , [ \begin{matrix}0 & 01 & 0 \\ 0 & 00 & 1 \\ 0 & 00 & 0 \\ 0 & 00 & 0 \\ 0 & 00 & 0 \\ 0 & 00 & 0 \\ 1 & 00 & 0 \\ 0 & 10 & 0\end{matrix} ] .$$

When d_{PS}=3, the 3 possible realizations of E corresponding of m_{PS}={0,1,2} are as follows

$$[ \begin{matrix}1 & 00 & 0 \\ 0 & 10 & 0 \\ 0 & 01 & 0 \\ 0 & 00 & 1 \\ 0 & 00 & 0 \\ 0 & 00 & 0 \\ 0 & 00 & 0 \\ 0 & 00 & 0\end{matrix} ] , [ \begin{matrix}0 & 00 & 0 \\ 0 & 00 & 0 \\ 0 & 00 & 0 \\ 1 & 00 & 0 \\ 0 & 10 & 0 \\ 0 & 01 & 0 \\ 0 & 00 & 1 \\ 0 & 00 & 0\end{matrix} ] , [ \begin{matrix}0 & 01 & 0 \\ 0 & 00 & 1 \\ 0 & 00 & 0 \\ 0 & 00 & 0 \\ 0 & 00 & 0 \\ 0 & 00 & 0 \\ 1 & 00 & 0 \\ 0 & 10 & 0\end{matrix} ]$$

When d_{PS}=4, the 2 possible realizations of E corresponding of m_{PS}={0,1} are as follows

$$[ \begin{matrix}1 & 00 & 0 \\ 0 & 10 & 0 \\ 0 & 01 & 0 \\ 0 & 00 & 1 \\ 0 & 00 & 0 \\ 0 & 00 & 0 \\ 0 & 00 & 0 \\ 0 & 00 & 0\end{matrix} ] , [ \begin{matrix}0 & 00 & 0 \\ 0 & 00 & 0 \\ 0 & 00 & 0 \\ 0 & 00 & 0 \\ 1 & 00 & 0 \\ 0 & 10 & 0 \\ 0 & 01 & 0 \\ 0 & 00 & 1\end{matrix} ] .$$

To summarize, m_{PS} parametrizes the location of the first 1 in the first column of E, whereas d_{PS} represents the row shift corresponding to different values of m_{PS}.

NR Rel. 15 Type-I codebook can be considered a baseline codebook for NR, with a variety of configurations. The most common utility of Rel. 15 Type-I codebook is a special case of NR Rel. 15 Type-II codebook with L=1 for Rank Indicator (RI)=1, 2, wherein a phase coupling value is reported for each sub-band, e.g., W_{2,l} is 2×N₃, with the first row equal to [1, 1, . . . , 1] and the second row equal to [e^{j2πØ}^{ₒ}, . . . e^{j2πØ}^{_{N3-1}}]. Under specific configurations, φ₀=φ₁= . . . =φ_{N}_{₃}₋₁, e.g., wideband reporting. For RI>2 different beams are used for each pair of layers.

For NR Rel. 16 Type-II codebook, it can be assumed a gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such cases, 2N₁N₂N₃ CSI-RS ports are utilized to enable DL channel estimation with high resolution for NR Rel. 16 Type-II codebook. In order to reduce the uplink feedback overhead, a Discrete Fourier transform (DFT)-based CSI compression of the spatial domain can be applied to L dimensions per polarization, where L<N₁N₂. Similarly, additional compression in the frequency domain can be applied, where each beam of the frequency-domain precoding vectors is transformed using an inverse DFT matrix to the delay domain, and the amplitude and phase values of a subset of the delay-domain coefficients are selected and fed back to the gNB as part of the CSI report. The 2N₁N₂×N₃ codebook per layer takes on the form

$${W}_{l} = {W}_{1} {\tilde{W}}_{2 , l} , {W}_{f , l}^{H} ,$$

where W₁ is a 2N₁N₂×2L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ]\end{matrix} ,$$

$${v}_{l , m} = [ {\begin{matrix}{u}_{m} & {e}^{j \frac{2 π l}{{O}_{1} {N}_{1}}} {u}_{m} & … & {e}^{j \frac{2 π l ( {N}_{1} - 1 )}{{O}_{1} {N}_{1}}} {u}_{m} ]\end{matrix}}^{T} ,$$

$$B = [ \begin{matrix}{v}_{{l}_{0} , {m}_{0}} & {v}_{{l}_{1} , {m}_{1}} & … & {v}_{{l}_{L - 1} , {m}_{L - 1}}\end{matrix} ] ,$$

$${l}_{i} = {O}_{1} {n}_{1}^{( i )} + {q}_{1} , 0 \leq {n}_{1}^{( i )} < {N}_{1} , 0 \leq {q}_{1} < {O}_{1} ,$$

$${m}_{i} = {O}_{2} {n}_{2}^{( i )} + {q}_{2} , 0 \leq {n}_{2}^{( i )} < {N}_{2} , 0 \leq {q}_{2} < {O}_{2} ,$$

where the superscript ^{T} denotes a matrix transposition operation.

Note that O₁, O₂ oversampling factors can be assumed for the 2D DFT matrix from which matrix B is drawn. Note that W₁ can be common across all layers. W_{f,l} is an N₃×M matrix (M<N₃) with columns selected from a critically-sampled size-N₃ DFT matrix, as follows

$${W}_{f , l} = [ \begin{matrix}{f}_{{k}_{0}} & {f}_{{k}_{1}} & … & {f}_{{k}_{M - 1}} ]\end{matrix} , 0 \leq {k}_{i} \leq {N}_{3} - 1 ,$$

$${f}_{k} = [ {\begin{matrix}1 & {e}^{- j \frac{2 π k}{{N}_{3}}} & … & {e}^{- j \frac{2 π k ( {N}_{3} - 1 )}{{N}_{3}}} ]\end{matrix}}^{T} .$$

Further, indices of the Z selected columns of B can be reported along with the oversampling index taking on O₁O₂ values. Similarly, for W_{f,l}, only the indices of the M selected columns out of the predefined size-N₃ DFT matrix can be reported. In the sequel the indices of the M dimensions are referred as the selected Frequency Domain (FD) basis indices. Hence, L, M represent the equivalent spatial and frequency dimensions after compression, respectively.

Further, the 2L×M matrix \tilde{W}₂ represents the linear combination coefficients (LCCs) of the spatial and frequency DFT-basis vectors. Both \tilde{W}₂, and W_{f,l} are selected independently for different layers. Amplitude and phase values of an approximately β fraction of the 2 LM available coefficients are reported to the gNB (β<1) as part of the CSI report. Note that coefficients with zero amplitude values are indicated via a layer-specific bitmap matrix Sₗ of size 2L×M, wherein each bit of the bitmap matrix Sₗ indicates whether a coefficient has a zero-amplitude value, wherein for these coefficients no quantized amplitude and phase values need to be reported. Since all non-zero coefficients reported within a layer are normalized with respect to the coefficient with the largest amplitude value (e.g., strongest coefficient), where the amplitude and phase values corresponding to the strongest coefficient are set to one and zero, respectively, and hence no further amplitude and phase information is explicitly reported for this coefficient, and only an indication of the index of the strongest coefficient per layer is reported. Hence, for a single-layer transmission, amplitude, and phase values of a maximum of ┌2βLM┐−1 coefficients (along with the indices of selected L, M DFT vectors) are reported per layer, leading to significant reduction in CSI report size, compared with reporting 2N₁N₂×N₃−1 coefficients' information.

For Type-II Port Selection codebook for NR Rel. 16, K (where K≤2N₁N₂) beamformed CSI-RS ports are utilized in DL transmission, in order to reduce complexity. The. The K×N₃ codebook matrix per layer takes on the form

$${W}_{l} = {W}_{1}^{PS} {\tilde{W}}_{2 , l} {W}_{f , l}^{H} .$$

Here, \tilde{W}_{2,l} and W_{f,l} follow the same structure as the conventional NR Rel. 16 Type-II Codebook, where both are layer specific. The matrix

$${W}_{1}^{PS}$$

is a AXZL block-diagonal matrix with the same structure as that in the NR Rel. 15 Type-II Port Selection Codebook.

Rel. 17 Type-II Port Selection codebook follows a similar structure as that of Rel. 15 and Rel. 16 port-selection codebooks, as follows

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports. For instance, the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, \tilde{W}_{2,l} and W_{f,l} follow the same structure as the conventional NR Rel. 16 Type-II Codebook, however M is limited to 1,2 only, with the network configuring a window of size N={2,4} for M=2. Moreover, the bitmap is reported unless β=1 and the UE reports all the coefficients for a rank up to a value of two.

For Rel-18 potential Type-II codebook, the time-domain corresponding to slots is further compressed via DFT-based transformation, wherein the codebook is in the following form

$${W}_{l} = {W}_{1} {{\tilde{W}}_{2 , l} ( {W}_{f , l} ⊗ {W}_{d , l} )}^{H} ,$$

where W₁, W_{f,l} follow the same structure as Rel-16 Type-II codebook, W_{d,l} is an N₄×Q matrix (Q≤N₄) with columns selected from a critically-sampled size-N₄ DFT matrix, as follows

$${W}_{d , l} = [ \begin{matrix}{d}_{{q}_{0}} & {d}_{{q}_{1}} & … & {d}_{{q}_{Q - 1}}\end{matrix} ] , 0 \leq {q}_{i} \leq {N}_{4} - 1 ,$$

$${d}_{q} = [ {\begin{matrix}1 & {e}^{- j \frac{2 π q}{{N}_{4}}} & … & {e}^{- j \frac{2 π q ( {N}_{4} - 1 )}{{N}_{4}}} ]\end{matrix}}^{T}$$

In implementations the indices of the Q selected columns of W_{d,l} are reported. Note that W_{d,l} may be layer specific, e.g., W_{d,1}≠W_{d,2}, or layer common, e.g., W_{d,1}= . . . =W_{a,RI}, where RI corresponds to the total number of layers, and the operator ⊗ corresponds to a Kronecker matrix product. Here, \tilde{W}_{2,l} is a 2L×MQ sized matrix with layer-specific entries representing the LCCs corresponding to the spatial-domain, frequency-domain and time-domain DFT-basis vectors. Thereby, a size 2L×MQ bitmap may need to be reported associated with Rel-18 Type-II codebook.

In scenarios a codebook report can be partitioned into two parts based on the priority of information reported. Further, each part can be encoded separately, such as described below. Part 1 of a CSI report can include RI+Channel Quality Indicator (CQI)+Total number of coefficients. Part 2 of a CSI report can include SD basis indicator+FD basis indicator/layer+Bitmap/layer+Coefficient Amplitude info/layer+Coefficient Phase info/layer+Strongest coefficient indicator/layer

Further, Part 2 CSI can be decomposed into sub-parts each with different priority, e.g., higher priority information listed first. Such partitioning can allow dynamic reporting size for codebook based on available resources in the uplink phase. Type-II codebook can be based on aperiodic CSI reporting, and reported in Physical Uplink Shared Channel (PUSCH)) via downlink control information (DCI) triggering. Type-I codebook can be based on periodic CSI reporting (e.g., Physical Uplink Control Channel (PUCCH)) or semi-persistent CSI reporting (PUSCH or PUCCH) or aperiodic reporting (PUSCH).

For priority reporting for Part 2 CSI, note that multiple CSI reports may be transmitted with different priorities, as shown in Table 1 below. Additionally, the priority of the N_{Rep} CSI reports can be based on the following:
1. A CSI report corresponding to one CSI reporting configuration for one cell may have higher priority compared with another CSI report corresponding to one other CSI reporting configuration for the same cell
2. CSI reports intended to one cell may have higher priority compared with other CSI reports intended to another cell
3. CSI reports may have higher priority based on the CSI report content, e.g., CSI reports carrying L1-reference signal received power (RSRP) information have higher priority
4. CSI reports may have higher priority based on their type, e.g., whether the CSI report is aperiodic, semi-persistent or periodic, and whether the report is sent via PUSCH or PUCCH, may impact the priority of the CSI report

Accordingly, CSI reports may be prioritized as follows, where CSI reports with lower identifiers (IDs) have higher priority

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

s: CSI reporting configuration index, and Mₛ: Maximum number of CSI reporting configurations;
c: Cell index, and N_{cells}: Number of serving cells;
k: 0 for CSI reports carrying L1-RSRP or L1-Signal-to-Interference-and-Noise Ratio (SINR), 1 otherwise;
y: 0 for aperiodic reports, 1 for semi-persistent reports on PUSCH, 2 for semi-persistent reports on PUCCH, 3 for periodic reports.

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
‘typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2NRep − 1:
Group 1 CSI for CSI report NRep, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

For triggering aperiodic CSI reporting on PUSCH, a UE is to report CSI information for the network using the CSI framework as in NR Release 15. A triggering mechanism between a report setting and a resource setting can be summarized in Table 2 below.

TABLE 2
Triggering mechanism between a report setting and a resource setting

| | | | | Antenna |
|---|---|---|---|---|
| | | Periodic | | Port (AP) |
| | | CSI | SP CSI | CSI |
| | | reporting | reporting | Reporting |
| Time | Periodic CSI- | RRC | MAC control | DCI |
| Domain | RS | configured | element (CE) | |
| Behaviour | | | (PUCCH) | |
| of | | | DCI (PUSCH) | |
| Resource | SP CSI-RS | Not | MAC CE | DCI |
| Setting | | Supported | (PUCCH) | |
| | | | DCI (PUSCH) | |
| | AP CSI-RS | Not | Not Supported | DCI |
| | | Supported | | |

Moreover, note the following:
Associated Resource Settings for a CSI Report Setting can have same time domain behaviour.
Periodic CSI-RS/Interference Management (IM) resource and CSI reports can be assumed to be present and active once configured by RRC
Aperiodic and semi-persistent CSI-RS/IM resources and CSI reports can be explicitly triggered or activated.
For aperiodic CSI-RS/IM resources and aperiodic CSI reports, the triggering is done jointly by transmitting a DCI Format 0-1.
Semi-persistent CSI-RS/IM resources and semi-persistent CSI reports are independently activated.

For aperiodic CSI-RS/IM resources and aperiodic CSI reports, the triggering can be done jointly by transmitting a DCI Format 0-1. The DCI Format 0_1 contains a CSI request field (0 to 6 bits). A non-zero request field can point to an aperiodic trigger state configured by RRC. An aperiodic trigger state in turn is defined as a list of up to 16 aperiodic CSI Report Settings, identified by a CSI Report Setting ID for which the UE calculates simultaneously CSI and transmits it on the scheduled PUSCH transmission.

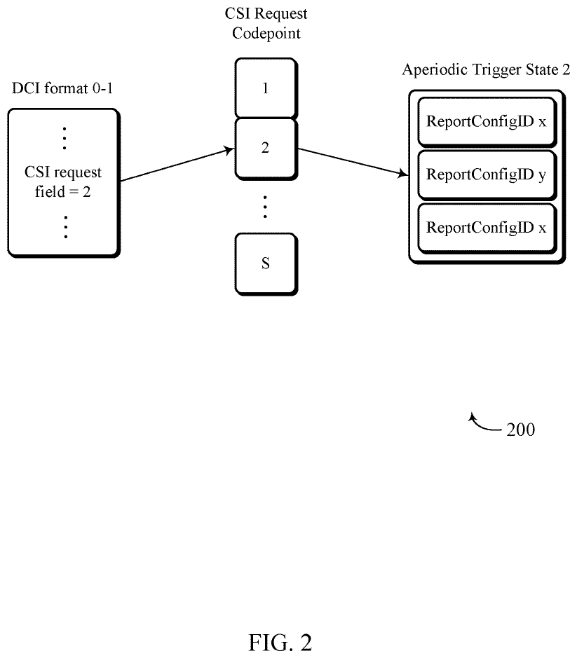

FIG. 2 illustrates a scenario 200 for aperiodic trigger state defining a list of CSI report settings. For instance, when a CSI Report Setting is linked with aperiodic Resource Setting (e.g., including multiple Resource Sets), the aperiodic non-zero power (NZP) CSI-RS Resource Set for channel measurement, the aperiodic CSI-IM Resource Set, and/or the aperiodic NZP CSI-RS Resource Set for IM to use for a given CSI Report Setting can be included in the aperiodic trigger state definition. For aperiodic NZP CSI-RS, the Quasi Co-Location (QCL) source to use can also be configured in the aperiodic trigger state. A UE can assume that the resources used for the computation of the channel and interference can be processed with the same spatial filter, e.g. quasi-co-located with respect to “QCL-TypeD.”

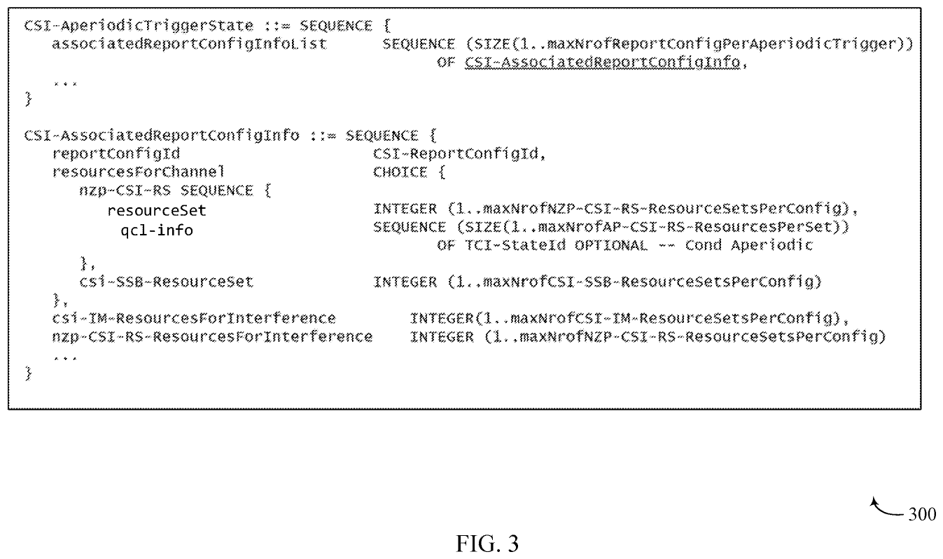

FIG. 3 illustrates an information element 300 for aperiodic trigger state indicating a resource set and QCL information.

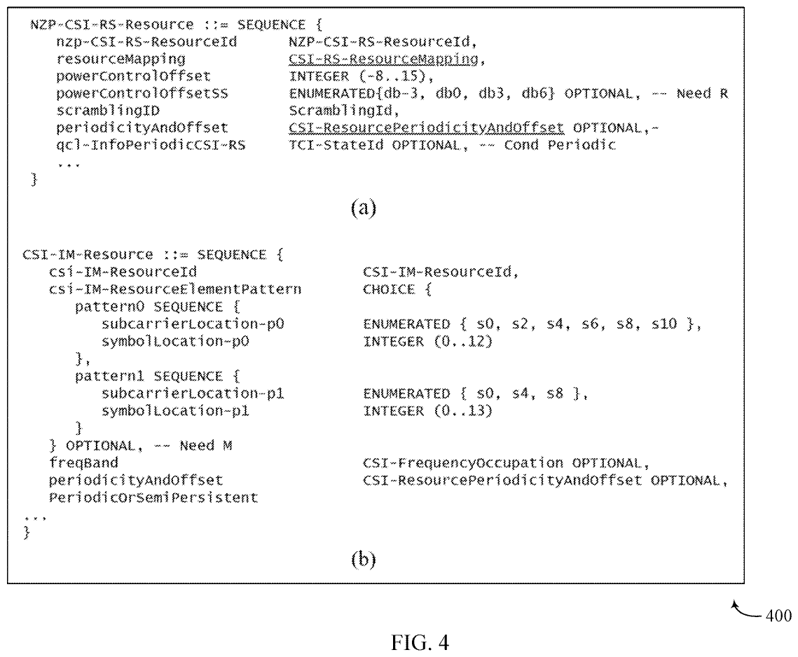

FIG. 4 illustrates an information element 400 for RRC configuration for NZP-CSI-RS/CSI-IM resources.

Table 3 below summarizes a type of uplink channels used for CSI reporting as a function of the CSI codebook type.

TABLE 3
Uplink channels used for CSI reporting as a
function of the CSI codebook type

| | Periodic CSI | | AP CSI |
|---|---|---|---|
| | reporting | SP CSI reporting | reporting |
| Type I WB | PUCCH | PUCCH Format 2 | PUSCH |
| | Format | PUSCH | |
| | 2, 3, 4 | | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 | | PUCCH Format 3, 4 | |
| only | | | |

For aperiodic CSI reporting, PUSCH-based reports can be divided into two CSI parts: CSI Part1 and CSI Part 2. CSI Part 1 can have a fixed payload size (e.g., and can be decoded by the gNB without prior information) and can contain the following:
RI (if reported), CSI-RS Resource Index (CRI) (if reported) and CQI for the first codeword;
number of non-zero wideband amplitude coefficients per layer for Type II CSI feedback on PUSCH.

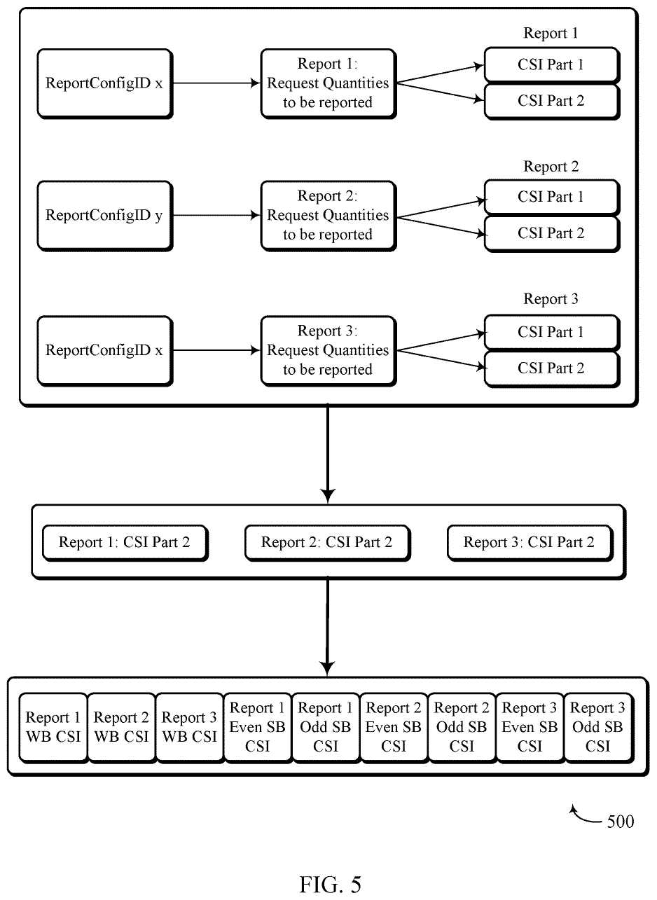

CSI Part 2 can have a variable payload size that can be derived from the CSI parameters in CSI Part 1 and contains Precoding Matrix Indicator (PMI) and the CQI for the second codeword when RI>4. For example, if the aperiodic trigger state indicated by DCI format 0_1 defines 3 report settings x, y, and z, then the aperiodic CSI reporting for CSI part 2 will be ordered as indicated in FIG. 5, which illustrates a scenario 500 for ordering for aperiodic CSI reporting.

In implementations, CSI reports can be prioritized according to:
1. Time-domain behavior and physical channel, where more dynamic reports are given precedence over less dynamic reports and PUSCH has precedence over PUCCH.
2. CSI content, where beam reports (e.g., L1-RSRP reporting) has priority over regular CSI reports.
3. The serving cell to which the CSI corresponds (in case of carrier aggregation (CA) operation). CSI corresponding to the PCell has priority over CSI corresponding to Scells.
4. The reportConfigID.

A CSI report may include a CQI report quantity corresponding to channel quality assuming a maximum target transport block error rates, which indicates a modulation order, a code rate and a corresponding spectral efficiency associated with the modulation order and code rate pair. Examples of the maximum transport block error rates are 0.1 and 0.00001. The modulation order can vary from Quadrature Phase Shift Keying (QPSK) up to 1024QAM, whereas the code rate may vary from 30/1024 up to 948/1024. One example of a CQI table for a 4-bit CQI indicator that identifies a possible CQI value with the corresponding modulation order, code rate and efficiency is provided in Table 4, as follows

TABLE 4
Example of a 4-bit COI table

| CQI | | code rate × | |
|---|---|---|---|
| index | modulation | 1024 | efficiency |
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

A CQI value may be reported in two formats: a wideband format, wherein one CQI value is reported corresponding to each PDSCH transport block, and a subband format, wherein one wideband CQI value is reported for the entire transport block, in addition to a set of subband CQI values corresponding to CQI subbands on which the transport block is transmitted. CQI subband sizes are configurable, and depends on the number of PRBs in a bandwidth part, as shown in Table 5, as follows:

TABLE 5
Configurable subband sizes for a given bandwidth part (BWP) size

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, e.g., using 4 bits for each subband CQI based on a CQI table, e.g., Table 4. If the higher layer parameter cqi-BitsPerSubband in CSI-ReportConfig is not configured, for each subband s, a 2-bit sub-band differential CQI value is reported, defined as:

$$Sub - band Offset level ( s ) = sub - band CQI index ( s ) - wideband CQI index .$$

The mapping from the 2-bit sub-band differential CQI values to the offset level is shown in Table 6, as follows:

TABLE 6
Mapping subband differential CQI value to offset level

| Sub-band differential CQI | |
|---|---|
| value | Offset level |
| 0 | 0 |
| 1 | 1 |
| 2 | ≥2 |
| 3 | <−1 |

In some wireless communications systems, the terms antenna, panel, and antenna panel are used interchangeably. An antenna panel may be a hardware that is used for transmitting and/or receiving radio signals at frequencies lower than 6 GHZ, e.g., frequency range 1 (FR1), or higher than 6 GHz, e.g., frequency range 2 (FR2) or millimeter wave (mmWave). In some implementations, an antenna panel may include an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In implementations, a device (e.g., UE, node) antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some scenarios, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or include a duration of time over which the gNB assumes there will be no change to the mapping. A Device may report its capability with respect to the “device panel” to the gNB or network. The device capability may include at least the number of “device panels”. In one implementation, the device may support uplink (UL) transmission from one beam within a panel; with multiple panels, more than one beam (one beam per panel) may be used for UL transmission. In another implementation, more than one beam per panel may be supported/used for UL transmission.

In implementations, an antenna port is defined such that the channel over which a symbol on the antenna port is conveyed can be inferred from the channel over which another symbol on the same antenna port is conveyed. Two antenna ports are said to be QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation, etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, e.g. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same receive beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In implementations, a Transmission Configuration Indication (TCI)-state associated with a target transmission can indicate parameters for configuring a quasi-collocation relationship between the target transmission (e.g., target RS of demodulation (DM)-RS ports of the target transmission during a transmission occasion) and a source reference signal(s) (e.g., Synchronization Signal Block (SSB)/CSI-RS/Sounding Reference Signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state includes at least one source RS to provide a reference (UE assumption) for determining QCL and/or spatial filter.

In implementations, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In implementations, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a component carrier (CC) or across a set of configured CCs/BWPs.

In implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated Physical Downlink Control Channel/Physical Downlink Shared Channel (PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

The development and integration of CSI frameworks for JCS has been studied to overcome some of the current 5G system drawbacks, e.g., high reporting overhead, one-shot CSI measurement, lack of channel tracking tools, etc. Some systems rely to this end on performing multi-shot CSI measurements including reporting high-resolution Doppler information of the channel into the CSI feedback in support of high mobility use cases. Such methodologies can allow a RAN to enhance its spectral efficiency of the downlink channel by extrapolating the signal precoder over time, such as to attempt to reduce signaling overhead of the CSI feedback and to predict movements of objects of interest over time in JCS fashion.

JCS methods can integrate communication algorithms and radio sensing methods into a combined framework targeting both tasks. Depending on the use-case, the expected communication service and QoS, the type of the required sensing information and sensing QoS, as well as the availability of means of communication and sensing (e.g., capable radio devices, time, frequency and energy resources), different processing algorithms have been proposed targeting diverse use-cases and joint communication and sensing scenarios. Moreover, methods of JCS can define a transmission/excitation of a signal intended jointly for sensing and information transfer, the methods of receiving and extracting the transmitted information, as well as processing used to extract environment information from the received signal.

Several methods have been proposed for resource allocation and scheduling for communication, radio sensing, co-existence of communication and sensing, and JCS operation. For instance, methods address beamforming, power, and/or bandwidth allocation in an integrated communication and sensing operation. Associated algorithms can target the optimization of a known communication metric (e.g., rate maximization, mean-square-error (MSE) minimization, energy-efficiency maximization, etc.) separately or jointly with optimization of radar sensing performance metrics. Such metrics can include detection probability maximization, false alarm rate minimization, ranging/positioning accuracy maximization for an object of interest under practical system and device constraints, e.g., limits of transmit power, available time, and frequency resources.

Furthermore, algorithms considering measurement and processing of a received signal have been considered separately or jointly from the algorithms targeting resource optimization and scheduling for radio sensing, communication, or jointly for communication and sensing, covering various radio sensing target KPIs. Such algorithms, for instance, are based on the analysis of time of flight, on the Doppler analysis, angular analysis, scattering pattern analysis or a combination thereof, revealing the properties of an object of interest in various signal processing domains. This includes, for instance: radio sensing systems for object detection where reliable knowledge of presence of an object is of interest and extension of which can be found for road safety and collision avoidance for pedestrian detection and for indoor presence detection addressing the indoor safety applications; where the presence of an object in an area of interest is examined via a hypothesis testing mechanism using the received signals intended for communication for radio sensing, or jointly for both.

Furthermore, scenarios have been considered for radio sensing for positioning and ranging enhancement, gesture detection, material/object classification, where the material scattering patten has been used to classify the content of the detected object, and the algorithms for health and vital sign monitoring, e.g., breathing and heart activity monitoring and rate estimation. For instance, such scenarios consider where the received signal pattern and/or the estimated channel information is utilized to extract specific features/patterns from the examined environment.

In applications of joint communication and sensing it is of interest to utilize multiple points of radio sensing measurements, e.g., via a distributed radar system and/or facilitating multiple radar and sensing sub-systems to collaboratively perform a radio sensing task. For such systems, methods of sensor information fusion among the distributed sensor measurements can be integrated into the resource allocation/scheduling as well as the underlying signal processing framework. Implementations consider, for instance, sensing and communication resource allocation of a multi-sensor radar performing a detection or estimation task and for passive distributed radar system. Methods of dynamic system optimization and online learning via dynamic programming methods have been proposed to address related environment and model dynamics, e.g., to track a moving object of interest and/or learning of the unknown model behavior.

One challenge in acquiring environmental awareness (e.g., sensing) is the interference management of desired and undesired radiative signals captured and/or transmitted over the RF front-end. The coexistence and interference management of separate communication and radar systems has been studied, yet the perspective of JCS and multi-objective/multiple tasks JCS optimization for interference management has not been well explored. A focus of such studies has been on attempting to develop efficient interference management techniques for the two individually developed and deployed communications and radar systems to operate smoothly without interference. In this context, where radar and communication systems may be co-located and physically integrated, the systems may transmit two different signals multiplexed in time, frequency and/or spatial domains. Their simultaneous operation can share the same physical resources cooperatively with a goal of minimizing interference to each other.

Research has been conducted into mutual interference cancellation in such scenarios, e.g., by means of beamforming design, cooperative spectrum sharing, opportunistic primary-secondary spectrum sharing, full duplex successive interference cancellation techniques, and dynamic coexistence. Effective interference cancellation, however, may have stringent requirements and constraints on mobility of nodes and information exchange between them, thus limiting the achievable spectral efficiency improvement of communications in practice. Another challenge in acquiring environmental awareness (e.g., sensing) in monostatic, bistatic or multi-static scenarios of both active and passive sensing scenarios applicable to JCS systems is the signal structure and physical waveforms associated with practical modern communications systems, e.g., LTE/5G/IEEE 802.11 family, and their waveforms.

For instance, specifically designed waveforms are used by radar systems, such as short pulses (in pulsed radar) and chirps (in frequency modulated continuous wave (FMCW) radar) to enable high power radiation and simple receiver processing. Nevertheless, it has been shown that these waveforms may not be exclusively necessary for radar sensing. For example, communications systems may employ passive radar or passive sensing techniques to exploit diverse radio signals for sensing, as in principle objects to be sensed can be illuminated by any radio signal of sufficient power. This can be a consequence of the aspect that the propagation of electromagnetic radio signals can be affected by dynamics of an environment, e.g., transceiver movements, dynamic surrounding objects and reflectors.

Accordingly, JCS waveforms have been considered to combine flexible physical characteristics and elements capable of integrating high spectral efficiency, range-Doppler ambiguity, synchronization and mobility robustness, while accommodating key components and technologies of modern mobile networks such as phased antenna array processing, broadband processing, e.g., channel aggregation, multi-user multiple-input multiple-output (MIMO) and OFDM access (OFDMA) paradigms. Research has shown progress in this sense by means of novel delay-Doppler modulation techniques and waveforms by discrete transforms (e.g., Zak/Wiener transforms) enabling orthogonal time-frequency space modulation (OTFS) as a candidate waveform for sensing in highly mobile environments, matching traditional radar systems while preserving spectral efficiency of state-of-art OFDM communications systems.

Algorithmic methods of JCS include the resource allocation and scheduling of a sensing operation in coexistence or jointly with communications, the coordination and synchronization of the multi-node, the multi-band coordination, synchronization, and fusion, as well as the signal processing for extracting the specific environment feature and/or sensing information of interest from the obtained sensing measurements. This can be achieved by radio sensing based on the analysis of time of flight, on the Doppler analysis, angular analysis, scattering pattern analysis or a combination thereof, revealing the properties of an object of interest in various signal processing domains. Moreover, the algorithmic design of the resource and signal scheduling of future systems can involve methods of model based mathematical optimization and data-aided supervised or unsupervised learning or a combination thereof. This can include the utilization of elements of deep learning for sensing or positioning function estimation, dynamic programming (e.g., reinforcement learning methods for learning of the scheduling mechanism), for signal processing and decision-making mechanisms, low-latency reporting (e.g., enabled by joint communication and sensing), and low latency processing, e.g., enabled by distributed processing jointly with processing parallelization of the radio sensing computations.

Accordingly, algorithmic components of JCS can be leveraged in establishing a multi-sensor scheduling, data collection, measurement aggregation and data extraction framework in communications technologies, such as 5G NR and beyond, and over radio access networks, such as 5G RAN and beyond. The utilization and integration of a plurality of sensor/receiver node measurements (e.g., via multiple sensor readings at different time instances, at different frequency bands, at different locations, and/or via different sensing data/measurement types) for environment sensing can be implemented to enhance the sensing accuracy and efficiency, e.g., object detection and/or positioning with a higher reliability/accuracy such as due to observation diversity.

As such, utilization of multiple sensor/node measurements in the context of a proposed JCS system can enable a JCS framework leveraging novel elements of sensing nodes configuration, sensing nodes grouping, sensing nodes reporting, and sensing nodes discovery and capabilities determination.

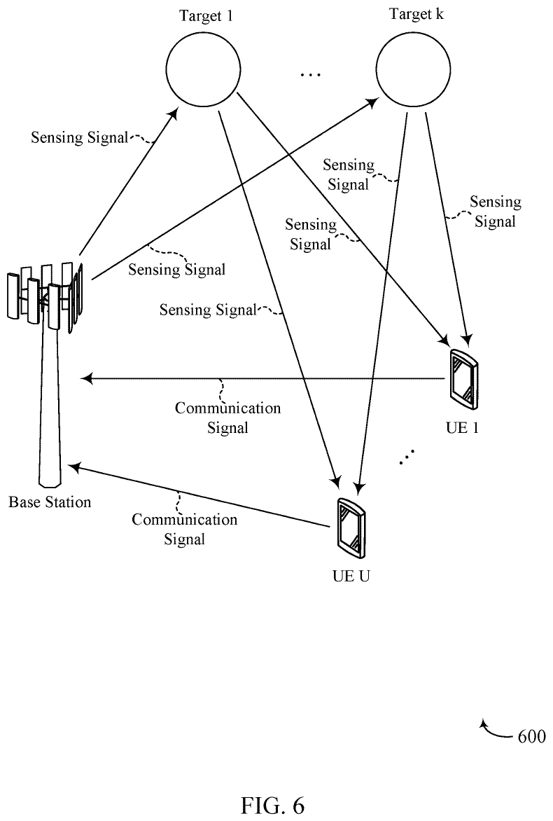

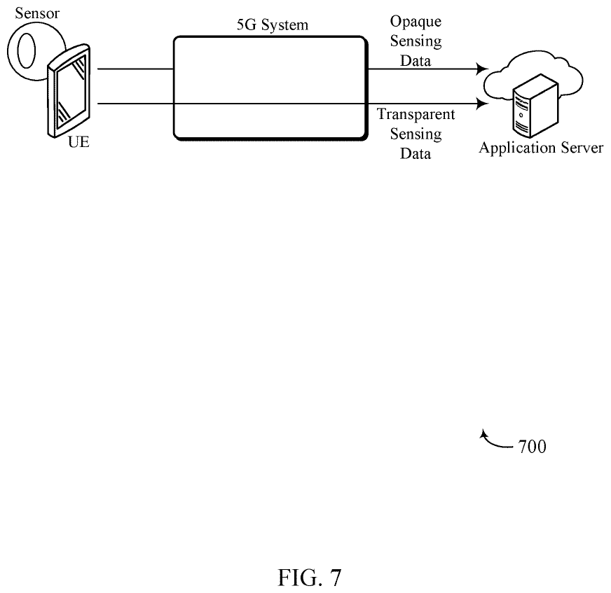

FIG. 6 illustrates a scenario 600 for a base station and UEs sensing target objects, and FIG. 7 illustrates a scenario 700 for opaque and transparent sensing data. For instance, a UE can sense using either or combination of sensors such as a camera, NR-based sensing and Lidar, Radar, etc. In NR-based sensing, the UE and base station (BS) can sense stationary and moving objects around the UE (e.g., using time-difference-of-arrival (TDoA), angle-of-arrival (AoA), angle-of-departure (AoD) measurements, received signal strength indicator (RSSI), etc. such as illustrated in the scenarios 600, 700. Transparent sensing, for instance, represents a use case in which sensing data is captured by the UE and communicated so that the 5G system can be aware of the sensing information. From this information, service enablers can be defined. One example of such information is location data, whose corresponding service enabler is Location Based Services. In a use case, sensing data is made available to the 5G system and parameters for this exposure are considered. The data so obtained can be used for diverse purposes, such as localization identifying both a 3D position and orientation.

In some scenarios a UE has access to one or more sensors. For instance, the UE has access to four sensors: NR-based sensing, 3D Lidar, a red green blue (RGB) camera, and a smartphone camera. Further, the sensors' physical configuration is known, e.g., the cameras are 10 cm apart. The NR-based sensing capabilities of the UE and its connected BS can be used to capture information about the nearby environment by the UE. A mobile network (MN) supports the acquisition of sensing data. This support by the network can be termed a ‘sensing data consuming service.’

In scenarios for considering sensing service flows such as in the scenario 600, a UE U can activate a mechanism to enable NR-based sensing at the UE and MN and provide sensing measurement data to the 5G system. This process is analogous to activating or enabling a location tracking service. The MN can acquire sensing measurement data provided by UE U for a period of time. Further, the UE U can deactivate the mechanism to provide sensing measurement to the 5G system.

In scenarios, the sensing data acquired by the 5G system can be processed to enable other services. For instance, the processed information can provide ‘Spatial Localization’ information that can be exposed to authorized third parties.

In scenarios, sensing has been considered in terms of interaction between a UE and a base station. This information may be partial, as it extends along a limited UE-base station axis. This information however can be considered a component of a scene that, when gathered with other available sensor data, can be synthesized into more comprehensive information. For instance, where the sensor is video, Lidar, sonar, etc., (e.g., the sensor operates in some other way than 3GPP defined radio access technology), it is still valuable to gather simultaneous sensor data and combine the sensor data. In this way sensor data can capture a scene, such as the front and back and sides of an object of interest, etc.

In a particular use case, on a construction site a crane is lifting a large object near a tower. Thus construction worker safety, efficient pursuit of tasks, and other situational awareness to prevent disasters are important tasks. Instead of merely relying on the crane operator, this use case allows the 5G system to model and track the tower, crane and payload as it is in motion. The use case can assume that sensors that can form a sensor group are UEs and/or communicate by means of a UE, e.g., as ‘split terminal equipment (TE)’ UE.)

In scenarios a ‘synchronous’ group of sensors and their movements can be captured in 3 dimensions to optimally combine the sensor data for the purpose of localization computations. This is particularly important when the viewer is near a large object or any non-static object must be modeled on all sides. In an example, a UE identifies a sensor group through interaction with an access stratum (AS). Part of identification of the sensors in the group is obtaining sufficient information that the user can become authorized to obtain sensor data, and the relevant service access information is obtained. The goal of the use case can be to enable the acquisition of sensor data in a UE's proximity.

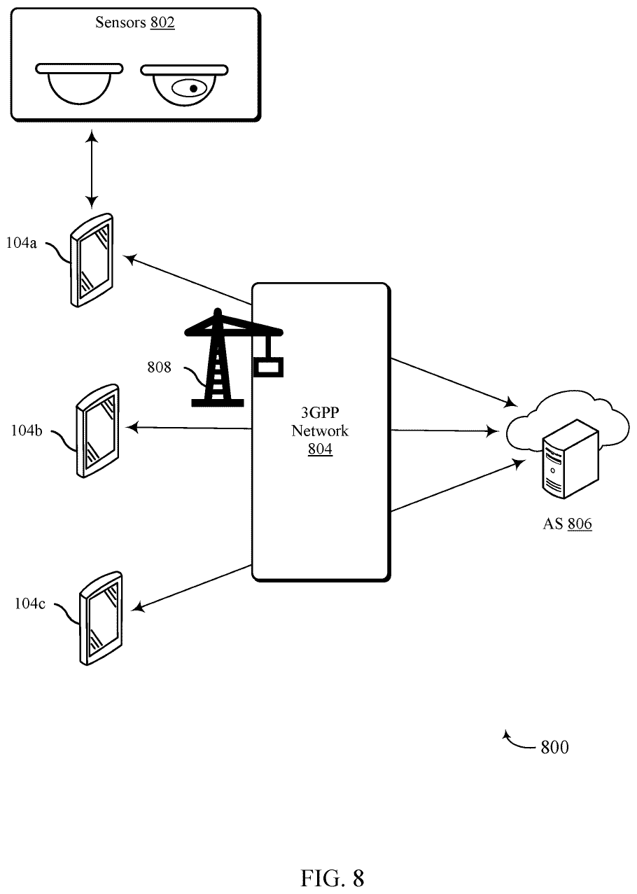

FIG. 8 illustrates a scenario 800 for UE-based sensing. The scenario 800 includes a UE 104a, a UE 104b, a UE 104c, sensors 802, a 3GPP network 804, and an AS 806. Consider, for instance, that the scenario 800 occurs on a construction site where a user has possession of the UE 104c and the UE 104c is equipped with a set of surveillance and appraisal applications. Further, the sensors 802 are deployed at the construction site. Examples of the sensors 802 include UEs (e.g., using NR-based sensing), video cameras, Lidar equipment, passive infrared sensors, etc. In implementations the sensors 802 are not installed directly in the terminal equipment but can use the UEs 104 (e.g., the UE 104a) to communicate, such as with the AS 806 over the 3GPP network 804.

In the scenario 800, UE 104a serves the sensors 802 that are themselves not UEs, and the UE 104a and the sensors 802 can communicate in various ways such as via wired and/or wireless connectivity. UE 104b is capable of 3GPP-defined sensing and UE 104c can operate a UE camera for sensing purposes. In this example UE 104a and 104b are authorized and ready to send mobile-originated sensing data to the AS 806.

Sensing measurement data (e.g., non-RF sensing) and sensing result (e.g., RF sensing) acquired by the AS 806 can be combined in software. In the scenario 800 the combination is performed by the AS 806. The user UE 104c is authorized to access media (e.g., the sensing result output of the AS 806 produced by taking account of the sensing measurement data from UE 104a, 104b, etc.) provided by the AS 806. According to scenarios the architecture shown in the scenario 800 is only an example and other architectures may additionally or alternatively be utilized. Thus, the user utilizing the UE 104c can monitor the construction site for safety and efficiency. In the following discussion, the UEs 104a, 104b, 104c can represent a “sensing group” and/or a “sensor group.”

The following represents examples of service flows that can occur within the scenario 800:
UE 104c uses functionality provided by the 3GPP network 804 to determine the existence of UE 104a, 104b;
UE 104c has knowledge of the AS 806 that accumulates sensor information;
UE 104c requests, from the AS 806 that accumulates sensor information for a sensor group, information about sensors that are in proximity;
UE 104c is able to become authorized to receive information concerning the sensor group;
AS 806 requests the 3GPP network 804 to obtain a sensing group;

The 3GPP network 804 can identify a set of UEs that provide the AS 806 with sensor information for sensors that are in the proximity to the UE 104c. The 3GPP network 804 can attempt to synchronously locate 4 or more devices to be localized within 10 cm of accuracy and with accuracy of measurement within 5 ms of synchronization;

The AS 806 can provide the UE 104c with information to identify a sensing group of UEs that are ready to provide sensing measurement data (e.g., for non-RF sensors) and sensing results (e.g., for RF sensors,) as well as how to get sensing data from the sensing group from the AS 806;

The UE 104c can request sensing measurement results from the sensing group. The sensors may be within a threshold proximity and the sensor locations are known with a threshold accuracy (e.g., within 10 cm in 3D) and with an accuracy of measurement within 5 ms of synchronization;

The UE 104c can be authorized to obtain sensing measurement results from the sensing group;

The UE 104a can provide sensing measurement data and UE 104b and/or the 3GPP network 804 can provide sensing results. The sensing results can be received by the AS 806 and combined. Further, the sensing result can be provided to the UE 104c by the AS 806;

The UE 104b can be mobile and its position can vary. The UE 104c can identify the position of the UE 104b with sufficient accuracy to interpret a sensing result. Since the UE 104b is mobile, its position and movements can be tracked to provide accuracy up to 10 cm and with accuracy of measurement within 5 ms of synchronization;

UE 104b can leave the proximity of the UE 104c and the UE 104c can identify that the UE 104b has left the sensing group. The UE 104b can return to proximity of the UE 104c and the UE 104c can identify that UE 104b has joined and/or rejoined the sensing group, including the position of the UE 104b within 10 cm and with accuracy of measurement within 5 ms of synchronization;

Accordingly, operations of a crane 808 can be monitored by the UEs 104a, 104b, which can provide different perspectives by means of sensing measurement data from non-RF sensors and sensing results from RF sensors to the AS 806.

Thus, a user making use of the UE 104c can ascertain with high accuracy the location and movement of the entire group of UEs 104 that can form a sensing group. The ability of UE 104c to identify the position and membership of the group continues over time, so that the current membership of the group is known, and that membership can change. Further, the AS 806 can be capable of combining the sensing measurement data acquired by non-RF sensors and sensing results acquired by RF sensors from different perspectives and produce a 3D representation of the site to the site supervisor, who can receive the sensing result by means of media delivered from the AS 806 to the UE 104c.

In various scenarios a function division between the network and the UE nodes for specific sensing tasks may take various forms, such as based on the availability of sensing-capable devices and the parameters of specific sensing operations. For instance, consider the following example scenarios.

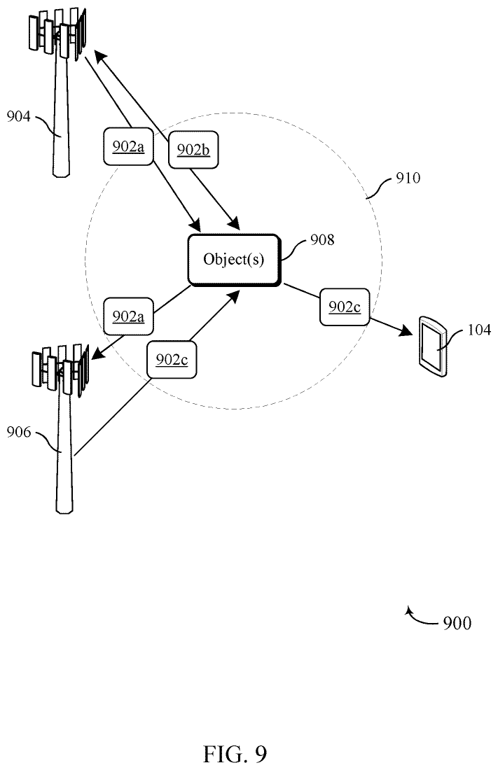

FIG. 9 illustrates example scenarios 900 for radio sensing that supports configuration for radio sensing in accordance with aspects of the present disclosure. The scenarios 900 include:

Scenario 902a with a sensing Tx as a network node 904 and sensing Rx as a separate network node 906, which represent different instances of network entities 102: In the scenario 902a, the sensing reference signal (and/or another reference signal used for sensing or data and/or control channels known to the network TRP nodes) is transmitted and received by network entities 102. The involvement of UE nodes can be limited such as to aspects of interference management. The network may not utilize UEs for sensing assistance in the scenario 902a.

Scenario 902b with a sensing Tx as the network node 904 and sensing Rx as the same network node 904: In the scenario 902b, the sensing reference signal (and/or another reference signal used for sensing or the data and/or control channels known to the network TRP nodes) is transmitted and received by the same network entity 102. The involvement of UE nodes can be limited such as to aspects of interference management. The network may not utilize UEs for sensing assistance in the scenario 902b.

Scenario 902c with a sensing Tx as the network node 906 and a sensing Rx as a UE 104: In the scenario 902c, the sensing reference signal or other reference signal used for sensing is transmitted by a network entity 102 and received by one or multiple UEs 104. A network, for instance, configures the UE(s) 104 to act as a sensing Rx node, such as according to the UE nodes capabilities for sensing and/or a specified sensing task.

As part of the scenarios 902a-902c, the radio sensing is implementing to detect feature characteristics of objects 908 present in an environment 910.

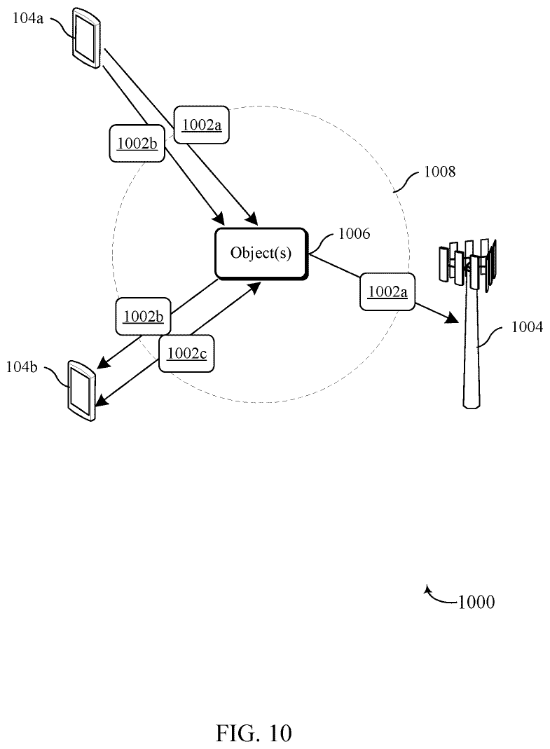

FIG. 10 illustrates example scenarios 1000 for radio sensing that support configuration for radio sensing in accordance with aspects of the present disclosure. The scenarios 900, 1000, for example, represent additional and/or alternative implementations. The scenarios 1000 include:

Scenario 1002a with a sensing Tx as a UE 104a and sensing Rx as a network node 1004: In the scenario 1002a, the sensing reference signal or other reference signal used for sensing (and/or a data and/or control channel transmitted by the UE 104a) is received by one or multiple network entities 102 (e.g., the network node 1004) and transmitted by the UE 104a. A network, for instance, configures the UE 104a to act as a sensing Tx node, such as according to the UE 104a capabilities for sensing and/or a specified sensing task.

Scenario 1002b with a sensing Tx as the UE 104a and a sensing Rx as a separate UE 104b: In the scenario 1002b, the sensing reference signal or other reference signal used for sensing is received by one or multiple UEs 104b and transmitted by the UE 104a. In this scenario, the network and/or a UE 104 may decide on configuration of the sensing scenario. In at least one example, a network configures the UEs 104 to act as a sensing Tx and/or sensing Rx nodes, such as according to the UE 104 capabilities for sensing and/or a specified sensing task.

Scenario 1002c with a sensing Tx as the UE 104b and sensing Rx as the same UE 104b: In the scenario 1002c, the sensing reference signal (and/or another reference signal used for sensing and/or the data and/or control channels known to the UE) is transmitted by the UE 104b and received by the same UE 104b. In at least one implementation, the UE 104b and/or a network configures the sensing scenario, such as according to the UE 104 capabilities for sensing and/or a specified sensing task.

As part of the scenarios 1002a-1002c, the radio sensing is implementing to detect feature characteristics of objects 1006 present in an environment 1008. Further, the different scenarios 902, 1002 are presented for purpose of example only, and it is to be appreciated that implementations for configuration for radio sensing can be employed in a variety of different scenarios including scenarios not expressly described herein.

Accordingly, solutions are provided in this disclosure for sensor network capability determination. It is to be appreciated that this disclosure is not limited to single implementations and/or implementation elements individually, and one or more elements from one or more implementations discussed herein may be combined in various ways not expressly illustrated herein.

Implementations discussed herein enable sensing activation for activating sensing for instances and groups of sensing nodes. For instance, for sensing activation, a network node (e.g., a network entity associated with a sensing configuration entity) can transmit configuration signaling to a set of sensor nodes corresponding to a sensing-aided network. The configuration signaling can include an activation message to a set of sensing nodes, and the activation message can correspond to on/off information for a plurality of sensing nodes. Further, the activation message may be common across the plurality of sensing nodes. In a first implementation, the activation message can be common for the set of sensing nodes. In a second implementation, the activation message can be common for a pre-configured subset of the set of sensing nodes. In a third implementation, the activation message can be in a form of a bitmap, where individual bits of the bitmap correspond to individual sensing nodes of the plurality of sensing nodes.

In implementations, activation and/or configuration signaling may include information corresponding to a time-domain behavior of sensor network reporting. For instance, in a first implementation, activated sensing nodes feedback a signal based on a periodic time-domain behavior. In a second implementation, activated sensing nodes feedback a signal based on a semi-persistent time-domain behavior. In a third implementation, activated sensing nodes feedback a signal based on a differential value corresponding to a slope, change, update, evolution of a given parameter value, etc., e.g., location of a device, or combinations thereof.

In implementations, sensing activation signaling includes an indication of a logical sensor ID and/or a sensing type ID, and the sensing activation, measurement, and/or reporting of a sensor node can be implemented at least based on: association of the sensor node to the indicated logical sensor ID (e.g., sensing configuration associated to an area of interest for sensing, such as sensing of an indicated angle/angular segment according to a globally or group-wise known coordinate system by the sensor group) and the sensing type ID, e.g., a measurement type, accuracy, etc.

In implementations, an activation message can be sent within an a priori indicated resource set to a group of sensor nodes, e.g., time-occasions and/or frequency occasions over which the activation signaling is indicated. Further, an activation resource configuration can be accompanied with an indication of a waveform type and/or parameters, such as when a waveform different than that of wireless communication access is used for activation of a low-power UE.

Implementations disclosed herein also enable sensing configuration information for sensor network capability determination. For instance, in implementations configuration signaling includes multiple parts including a first part that corresponds to an activation message (such as discussed above) and a second part that corresponds to activated sensing nodes based on the activation message in the first part.

For instance, in implementations the second part corresponds to time, frequency, and/or spatial (e.g., beam and/or photo pixel) domain information corresponding to activated sensing nodes. In a further implementation, the second part corresponds to a resolution of reporting of a subset of one or more sensing nodes of activated sensing nodes. In a further implementation, the second part corresponds to location information in terms of 2D and/or 3D coordinate values corresponding to a measured location as part of a localization task.

In implementations, sensing configuration is activated and/or triggered based on an event, and a sensing node feeds back a first message corresponding to a first feedback mode including a parameter, and the sensing node feeds back a second message corresponding to a second feedback mode based on a value of the parameter. For instance, the second message is larger in size than the first message and/or the configuration signaling corresponds to the second message.

Implementations described herein further enable sensor grouping and/or sensor network grouping. For instance, in implementations a network node configures K sensing nodes to carry out the sensing process, where the K sensing nodes are grouped into L logical sensors, L≤K, and each logical sensor comprising kₗ sensing nodes, such that

$${\sum }_{l = 1}^{L} {k}_{l} = K .$$

In implementations, the number of sensing nodes per logical sensor can be fixed for all logical sensors, e.g., approximately K/L sensing nodes exist per logical sensor. In implementations, all K sensing nodes are associated with a same logical sensor.

In implementations, each sensing node of the K sensing nodes is associated with a distinct logical sensor. For instance, K logical sensors occur with one-to-one mapping between logical sensors and sensing nodes. In implementations, a parameter including mapping of each of the K sensing nodes to the L sensors is included in the configuration signal, e.g., KL bits (bitmap) or K·log₂ L bits. In implementations, a logical sensor can be referred by one of a sensor port and/or a sensing port.

In implementations, each sensing node may be associated with one or multiple logical sensors and/or sensing type/tasks. Further, a logical sensor can be associated with a logical sensor ID and a sensing task and/or sensing type of a logical sensor can be associated with a sensing type ID. In implementations, a logical sensor can be associated with a sensing task. In at least one example implementation, a group of 10 sensing nodes in a 2 meter radius of a sensing target, among a total of 100 sensing nodes, can be associated with a logical sensor ID 1, and multiple sensing types are indicated to associate different spatial parts (e.g., angles and/or segments of the sensing target) to each sensing type of the logical sensor.

In implementations, sensing configuration includes an indication of physical uplink resources to be used for a corresponding sensing report fed back by the sensing nodes over a physical uplink channel, and a utilization of the physical sensing resources can be based on a sensing event corresponding to the sensing process. For instance, in at least one implementation, a set of sensing nodes including a group of physical uplink resources can be configured by the network, and the sensing nodes can select a subset of the physical uplink resources based on monitored sensing events.

In implementations, the physical uplink resources can be utilized and the sensing report is fed back with repetition over the uplink resources when a number of sensing events is below a pre-determined threshold value, e.g., one. In implementations, the physical uplink resources correspond to time-domain resources, frequency-domain resources, a pair of time-domain and frequency-domain resources, or combinations thereof.

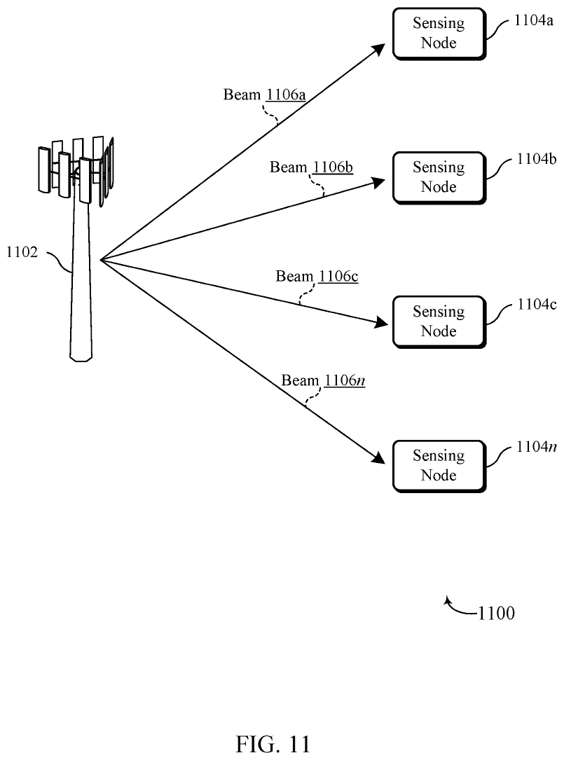

FIG. 11 illustrates a scenario 1100 that supports sensor network capability determination in accordance with aspects of the present disclosure. The scenario 1100, for instance, illustrates an example of pairing of Tx Beams of a network node with a set of logical sensors. The scenario 1100 includes a network node 1102 (e.g., a network entity 102) and sensing nodes 1104 including a sensing node 1104a, a sensing node 1104b, a sensing node 1104c, and a sensing node 1104n. The sensing nodes 1104, for instance, represent different instances of logical sensors.

In implementations such as represented by the scenario 1100, the network can implement a procedure with the sensing nodes 1104 of a sensor network that is similar to the initial access procedure between the network node and the UEs such as described above. For instance, the network node 1102 performs a beam sweeping with transmission of reference symbols via different beams 1106 to the sensing nodes 1104 via a beam 1106a, a beam 1106b, a beam 1106c, and a beam 1106n.

In implementations each sensing node 1104 (e.g., each logical sensor) can report an indication of a strongest beam from the beams 1106. The indication can be in a form of a bitmap and/or a combinatorial indicator corresponding to a beam index, and each beam 1106 can be associated with a distinct resource, e.g., frequency-domain resource, time-domain resource, or a resource pair corresponding to both time-domain and frequency-domain.

In implementations, each beam 1106 can correspond to a distinct NZP CSI-RS resource, and the NZP CSI-RS resources associated with the beams 1106 can be higher-layer configured with a parameter ‘repetition.’ In implementations, each beam 1106 corresponds to a distinct reference signal resource, and the reference signal is associated with a sensing task. In implementations, the indication of a strongest beam 1106 is in a form of a CRI value that is fed back as part of a sensor-generated report, e.g., a CSI report.

According to implementations, in response to the beam indices received from the sensor network, the network maps each sensing node 1104 to a distinct beam 1106, e.g., each sensing node 1104 and/or logical sensor can be associated with a specific beam 1106 for sensing purposes. In implementations, sensing nodes 1104 corresponding to a same logical sensor can be associated with a same beam 1106 and/or share beam-defining parameters, e.g., a sensing target area indicated according to a known coordinate system of a sensor group. Alternatively or additionally, a pairing of the sensing nodes 1104 and/or logical sensors based on its corresponding location in the form of 2D or 3D coordinates is not precluded.

Implementations described herein enable sensing reporting such as for reporting sensing measurements by sensing nodes. In implementations, when a sensing node receives the sensing configuration from the network via one or more network nodes, the sensing node can internally configure its sensing process operations. For instance, the sensing node activated by a first part of the sensing configuration utilizes on the second part of the sensor configuration to provision its resources for sensing processes. A sensing process, for instance, establishes for a sensing node a sensing task to be performed for the sampling of an environment based on sampling of a signal reference. This operation can involve processing of one or more signals affected by an environment and that are processed against a signal reference as determined by the second part of the sensor configuration provisioning.

In implementations, the sensing process configures the sensing node to perform a sensing task for determining whether a dominant path (e.g., LoS) is available for radio propagation at a location of the sensing node. In such an example, CSI reference can be used to acquire CSI measurements at the sensing node, such as while the sensing task of the sensing node is LoS detection based on the determined CSI measurements.

In implementations, the sampling and processing of the environment described herein can result in the derivation of an output sensing signal which can be used by a sensing node for further processing in performing a sensing process. For example, in a LoS detection sensing task, a sensing node can use a transformed version (e.g., based on Principal Component Analysis, or alternatively, based on a canonical or deep learning embedding) of the CSI measurements to determine an output CSI measurement as the output sensing signal. The output may in some examples include extracted dominant paths and/or features of dominant paths which are used to identify and estimate the probability of a LoS path. In an additional or alternative example, a similar processing may be applied to other canonical sensing problems like predictive blockage detection or channel rank estimation.

In implementations, sensing node processing can determine based on a signal reference a detection of a sensing event relative to a configured sensing task. In an example of LoS detection, the sensing event can correspond to detecting a LoS path existence within a radio-frequency propagation environment. In an example of predictive blockage detection, a blockage event can correspond to a sensing node detecting a present or future blockage event where the environment is blocked by a non-transparent object with respect to a sampled signal energy propagation. In some scenarios this signal may be one of an electro-magnetic signal (e.g., of radio frequency and/or optical/visual nature), a sound pressure wave signal, a heat dissipating signal (e.g., which can be sampled by an infrared sensor), etc.

In implementations, a sensing node can feed back to a network a sensing report as configured by the sensing configuration provisioning. For instance, the sensing node indicates by at least one part within a sensing report a determined state of a sensing event and the output sensing signal processed to determine a sensing event state. The sensing report can be fed back by the sensing node to the network wirelessly over a set of determined radio resources, and the determination of the radio resources can be based at least in part on the second part of the sensing node configuration. The radio resources can be one or more of time, frequency, or spatial (e.g., spatial beam) resources, or combinations thereof. Further, the radio resources can be singular resource entities or grouped in blocks of radio resources within a 3D time-frequency-spatial resource allocation space.

In implementations the sensing report may be fed back by the sensing node to the network node over two time slots, such as two resource blocks and one spatial stream over an 5G NR Uu interface in an UL direction. The numerology configuration and displacement of resources in time-frequency-spatial resource space can be in an example based in part on the second part of the sensing configuration, e.g., whereby the resources for the sensing report are provisioned.

In implementations, the sensing node feeds back to the network a plurality of sensing report parts by UL transmission to one or more network nodes. Further, at least one part of the sensing report can be transmitted over radio resources (e.g., time slots, frequency resources, spatial beams, etc.) which have been pre-determined statically by the at least one of the first or second sensing configuration.

In implementations, upon activation by the first part of the sensing configuration of the sensing node, the sensing node can be configured and provisioned by the second part of the sensing configuration to use a particular pattern of time, frequency, and/or spatial resources to transmit in UL its sensing report to the network.

In implementations, a sensing node feeds back to the network the plurality of the sensing report parts by UL transmission to one or more network nodes. The at least one part of sensing report can be transmitted over radio resources (e.g., time slots, frequency resources, spatial streams, etc.) which have been pre-determined statically by at least one of the first or second sensing configuration. In implementations, at least a second, or alternatively, a second and third part of the sensing transport can be subsequently transmitted over a dynamically allocated set of radio resources. The latter can be determined in such an embodiment by at least one part of the sensing report transmitted over the pre-determined resources. This indication procedure can efficiently use radio resources and dynamically allocate them based on the sensing events detected by the sensing node as indicated within the at least first part of the sensing report.

In implementations, the first part of the sensing report indicates jointly the activation and sensing event detection for a sensing node out of a pool of sensing nodes within the sensor network. This indication can be signaled in UL based on pre-determined radio resources as indicated by the first part of the sensing configuration. Based on this indication and on the active second part sensing configuration, the network can dynamically allocate radio resources for the reporting of remaining portions of a sensing report from the sensing node. For instance, the remaining portions of the report may coincide to the sensing node reporting the output sensing signal as a set of one or more estimated sensing parameters, e.g., CSI tap-delay power parameters, Doppler-delay CSI parameters, channel rank parameter, etc.

In implementations, one or more sensing nodes may be commonly grouped and activated based on the first part of the sensing configuration. In some examples this group-common activation can enable one or more sensing nodes to form a logical sensor. For instance, a logical sensor can provide indications of sensing reporting in a distributed manner, where the grouped individual sensing nodes feed back their own sensing reports based on at least one of the group-common and sensor-specific sensing configuration provisioning via the second part of the sensing configuration.

In implementations, a group-common sensing configuration may be performed over a physical broadcast channel, a physical multicast channel, a point-to-point physical downlink control channel indication, etc.

In implementations, sensor-specific sensing configuration may be performed over a physical broadcast channel, a physical multicast channel, a point-to-point physical downlink control channel indication, etc.

In implementations, a logical sensor can provide indications of its sensing in an aggregated manner, whereby at least one sensing node of the logical sensor can aggregate sensor reports of other sensing nodes included part of the logical sensor. In such implementations, the logical sensor can be configured by the network as a primary sensing node for a logical sensor. The primary sensing node can aggregate sensing reports of logical sensor peers into an aggregated logical sensor sensing report. Furthermore, the primary sensing node can feed back to the network the aggregated sensing report of the logical sensor. This type of sensing reporting can be a centralized sensing reporting with logical sensor aggregation and as such, the network can observe the logical sensor as a single entity, e.g., as a virtualized sensing node instance implemented by the logical sensor.

In implementations, the primary sensing node may be collocated with one of the network nodes. Alternatively, the primary sensing node may not be collocated with one of the network nodes but may be collocated with a UE and/or a group of sensing nodes with which the primary sensing node forms the logical sensor.

In implementations, the primary sensing node may have more advanced sensing or processing capabilities than its peers (e.g., other sensing nodes) within the logical sensor. Furthermore, from a network and sensing reporting functional perspective, the aggregated sensing reporting of a logical sensor by means of a primary sensing node can be equivalent to the sensing reporting of an instance of sensing node. Thus, implementations described herein regarding sensing report indications are applicable to both centralized and/or aggregated logical sensor and distributed and/or sensing node sensing reports. In implementations, considering that a logical sensor can be formed of a single sensing node, the terms sensing node and logical sensor can be used interchangeably with respect to a sensing report when addressing singular sensing nodes instances.

As indicated above, a sensing report may include multiple parts. For instance, a sensing report of a sensing node and/or an aggregated sensing report of a logical sensor can include at least three parts.

For instance, consider implementations with a sensor network of K sensing nodes and L logical sensors. In implementations, a first part of the sensing report includes an indication of one or more activated logical sensors out of the L logical sensors, whereby each indicated logical sensor can detect a sensing event according to the network configured sensing configuration.

In implementations, where K=L (a logical sensor is a sensing node) and as such the indication of the first part of the sensing report of a logical sensor can be a mapping of one-to-one to a sensing node.

In implementations where K>L≥1, at least one logical sensor may be formed of more than one sensing node. Accordingly, to support distributed reporting and indicating individual sensing reports of sensing nodes, mapping of logical sensors to one or sensing nodes can be implemented. In such implementations the indication of one or more activated logical sensors can be represented as a bitmap formed of L bits where each bit indicates the activated logical sensor, or alternatively, a sensing node which additionally detected the sensing event according to the network configured sensing task.

In implementations the L bits bitmap includes a bit corresponding to each of the L logical sensors indicating a value l according to the logic clauses and mapping below:
Non-activated logical sensor l OR non-detected sensing event by logical sensor l maps to l=0;
Activated logical sensor l AND detected sensing event by logical sensor l maps to l=1

In implementations, a first configuration part indication of a logical sensor can be implemented based on a common UL signaling among the sensing nodes associated with a logical sensor, where the UL signaling of the sensor nodes of the logical sensor can share a transmission time-frequency resource, a modulation, and/or an encoding configuration.

In implementations, a receiving network node (and/or a receiving primary sensing node of a logical sensor of one or more sensing nodes of a plurality of sensing nodes) performs, upon receiving the first part indication, a combined logic. The combined logic can aggregate the information from each sensing report into a common sensing report with respect to a first part of sensing reports of sensing nodes of a corresponding logical sensor.

In implementations, such combined logic may take the form of a XOR based on a common sensor configuration and a logical sensor grouping. The XOR operation can be used on a receiving end to determine, based on the individual sensing reports of sensing nodes of a logical sensor, the activity and state with respect to a sensing event of the logical sensor.

In implementations, the combined logic may be a physical propagation phenomenon of a superposition of RF waveforms belonging to sensing reports of one or more sensing nodes of a logical sensor. The RF waveforms can encode transmissions over the same UL signaling resources in time, frequency, and/or space, whereby common detection on the receiving end can aggregate and/or detect the logical sensor state.

In implementations, for a sensing report, such as where K>L≥1, a second part of a sensing report can be implemented to disambiguate and map a logical sensor to its constituent sensing nodes. For instance, the second part of the sensing report can be indicating a L′≤L groups of bits, whereby L′ represents the total number of logical sensors indicated with l=1 according to the first part of the sensing report.

In implementations, the second part of the sensing report includes a mapping of detected sensing events to sensing nodes based, for example, on the first part of the sensing report. For instance, each subgroup l of bits of the L′ group of bits corresponds to an indication of the one or more sensing nodes that detected the sensing event for the logical sensor and/or subgroup l. In an example implementation the indication of the one or more sensing nodes can be represented as a bitmap representation corresponding to the L′ groups of bits as individual bitmaps. In such an example, the bitmap width of each subgroup of bits of the L′ groups of bits can be determined as kₗ, whereby k represents the number of sensing nodes forming the logical sensor l of the L′ logical sensors signaled by the first part of the sensing report. Accordingly, kₗ can be determined based on the sensing configuration provided by the network.

In implementations that include a subgroup of bits (e.g., l), a bitmap of length kₗ can be used to determine which sensing node of the kₗ sensing nodes was activated and detected the sensing event according to the sensing configuration set by the network. For instance, a same bitmap encoding as for the first part of the sensing report can be used.

In implementations, the indication of the second part of the sensing report can be represented as a combinatorial encoding as a codeword corresponding to the L′ groups of bits. In such an example, the bitfield length of each logical sensor l group of bits of the L′ groups of bits can be determined semi-statically as

$$⌈ {log}_{2} ( \begin{matrix}{k}_{l} \\ {k}_{l}^{′}\end{matrix} ) ⌉$$

bits. This can determine the codebook size of combinations of

$${k}_{l}^{′}$$

sensing nodes that were activated and detected the sensing event out of the kt total sensing nodes of the l logical sensor. Therefore, each of the L′ logical sensors can be signaled based on their own combinatorial codebooks and codewords, such as to provide a compressed indication in comparison with a bitmap alternative.

In implementations, the indication of the second part of the sensing report can be represented as a first combinatorial encoding as described herein followed by a second stochastic run-length encoding. The second stochastic run-length encoding can be used to losslessly compress the codebook size of the first encoding based on codebook statistics. In an example, the second run-length encoding used is the Huffmann code. In implementations where K=L, the first and the second part of the sensing report can be the same and, in some implementations, one of the two, e.g., the second part, can be skipped from reporting.

In implementations, sensing report indications corresponding to the second part of one or more sensing nodes of a logical sensor can be combined and aggregated on the receiving endpoint, e.g., a network node and/or a primary sensing node of a logical sensor. The combining logic and/or aggregation of information can be performed with respect to the logical sensor whereby the independent second part information reported by the one or more sensing nodes of the logical sensor can be further aggregated.

In implementations, where a bitmap representation of a second part of the sensing report is implemented, an XOR logic can be applied as a combination, or alternatively, fusion and/or aggregation logic.

In implementations, where combinatorial encoding based on a common codebook is applied for the second part of sensing reporting, the combination can be performed post-decoding of independent information reported by each sensing node. In examples, where codebook design enables superposition and aggregation of codewords (e.g., analog encodings, homomorphic encodings, etc.), the independent information can be aggregated pre-decoding into a single information stream which can then be commonly decoded to retrieve the combined, aggregated, and/or fused second part indication of a sensing report from a logical sensor.

In implementations, for a third part of a sensing report, the third part of the sensing report may be signaled in UL to the network by an activated sensing node that detected a sensing event according to the network-provided sensing configuration. The sensing node, for instance, can provide the third part of a sensing report based on the sensing task and sensing configuration provisioning of resources, whereby the third part includes a set of one or more sensing parameters reports.

In implementations, sensing reports corresponding to the third part of the sensing reports can be determined dynamically by the network based on the first and second part indications of the sensing reports which specify how many and which of the K sensing nodes of the sensor network have been activated and have detected a sensing event according to the sensing configuration and associated sensing task.

In implementations, an indication corresponding to a third part of the sensing report mapping to a set of one or more sensing parameter reports can be determined semi-statically, such as based on sensing configuration and a representation encoding of the sensing parameters to be reported by a sensing node when a sensing event is detected. Thus, a set of one or more sensing parameters for a sensing node may include one or more of the following representations as configured by a sensing task provisioned by the sensing configuration of the network:
a. A set of one or more parameters determining a Channel State Information (CSI) estimation, e.g., complex gains of dominant delay profile taps, complex gains of dominant Doppler-delay channel representation, complex gains of dominant time-frequency channel representation either in compressed (e.g., DFT encoded as per 5G NR CSI framework) or non-compressed form, etc.;
b. A set of Reference Signal Received Power (RSRP) parameter estimation;
c. A beam index parameter estimation based on some preconfigured beam codebook or a beam codebook determined by the beam-sensor pairing configuration;
d. A beam management parameter estimation;
e. A set of one or more parameters representing an encoding of one of an Angle of Arrival (AoA) or an Angle of Departure (AoD) parameter estimation;
f. A signal strength parameter estimation comprising of one of a Signal-to-Interference-Noise Ratio (SINR), or alternatively, a Signal-to-Noise Ratio (SNR) metric;
g. A set of parameters measuring the channel rank estimation;
h. A set of metrics encoding a representation of the characteristics of multiple path propagation parameters (e.g., dominant path/cluster of paths, line of sight (LOS), non-LOS (NLOS) detection) estimation; and/or
i. A set of metrics encoding the detection of a signal propagation blockage via the surrounding environment of the sensing node.

Accordingly, a third part of the sensing report can provide sensing parameter traces to the network that triggered, at individual sensing nodes within the sensor network, the detection of sensing events. This can provide statistical data that the network can aggregate towards sensing for statistical inference based decisions and/or insights into the decision making and detection processing of the individual sensors. In implementations the network may thus optionally configure the reporting of the third part of the sensing report based on a specified sensing task and objectives from the network perspective.

In implementations a sensing reference used by a sensing node may be based on a model reference signal used in a correlation hypothesis test to estimate and determine a sensing parameter or output sensing signal. In implementations, however, the sensing reference may utilize a stochastic, or alternatively, inference-based trained filter, e.g., as an artificial intelligence (AI) neural network or a machine learning (ML) trained stochastic inference model. Accordingly, the sensing reference can be used to determine an output sensing signal, to detect a sensing event, and/or to estimate a set of one or more sensing parameters according to a sensing task as configured by the network.

In implementations such procedures can be based on processing acquired samples and/or features of an environment as inputs to the sensing process with respect to the sensing reference.

In implementations the sensing reference can be represented as a model reference signal which may be an electromagnetic reference signal within radio frequency and/or optical spectrum that is used to excite the environment surrounding the physical location of a sensing node in order to determine physical characteristics of the environment. This measurement can be based on a sensing process of a sensing node as configured based on the network sensing configuration.

In implementations a reference signal may be determined based on a set of existent reference signals within the scope of the network, e.g., as CSI-RS, DM-RS, Phase Tracking Reference Signal (PT-RS), positioning reference signal (PRS) reference signals, etc., available in 5G NR. In implementations, the reference signal may be specific to the sensing task and signaled to the sensing nodes based on a sensing configuration.

In implementations, the reference signal may be external to a sensing node, such as originating from one or more network nodes based on the network sensing configuration. In such implementations the sensing reference signal can be produced by one or more network nodes under the control of the network.

In implementations, the reference signal may be internal to a sensing node, e.g., whereby the sensing node generates the sensing reference signal internally and acquires its reflections and/or transformation via a surrounding environment given the network provide sensing configuration and its corresponding sensing task. For example, such implementations may be specific to radar-specific nodes where radio-frequency sensing reference signals may be used to determined specific characteristics (e.g., blockage, reflectors) in the sensing node environment.

In implementations, the characteristics of a physical placement of a two or more sensing nodes can be quasi-collocated (QCL) with respect to a propagation environment, such that various sensing parameters can be substantially equivalent among the two or more sensing nodes. In such environments, the network may determine sensing configurations grouping quasi-collocated sensors within a logical sensor and aggregating sensing reports for such configurations. For example, in a scenario where the network is signaling sensing references to two or more sensing nodes, the sensing nodes can be QCL when large-scale properties of the propagation environment and/or a channel over which the sensing reference is conveyed to one sensing node is statistically highly correlated and can be inferred from other sensing nodes whereby the same sensing reference is propagated over their environments and/or channels. In such examples, large-scale properties can include one or more of delay spread, Doppler spread, Doppler shift, average gain, average delay, spatial Rx parameters (e.g., AoA), etc. As such, two or more sensing nodes may be QCL with respect to a subset of the large-scale properties of their environment. In such examples, the network can use such information to lower the sensing report overhead and gain in resolution by exploiting diversity and aggregation of sensing reports. This can be performed in many implementations by means of logical sensor grouping and aggregated reporting as discussed above. In implementations, the physical placement of such sensing nodes can be QCL with respect to a sensing task over an environment.

According to implementations, a sensor group can be interpreted as one or more of:
a) Sensing nodes of a logical sensor, where a number of the logical sensors can be equivalent to a number of the sensor groups. For instance, a mapping of sensor groups to sensing nodes can be equivalent to a mapping of the logical sensors to the sensing nodes.
b) Sensing nodes of multiple logical sensors, where a number of the logical sensors can be equivalent to an integer multiple of a number of the sensor groups.
c) A plurality of sensing nodes, where a mapping of the sensor groups to the sensing nodes can be different from a mapping of the logical sensors to the sensing nodes.

In implementations a sensor device can be interpreted as a sensor node and/or a logical sensor. It is to be appreciated that any combined interpretation of the above is not excluded from the implementations of the current disclosure.

In implementations, a sensing node is a UE device, a RAN node (e.g., a gNB, an IAB node, an RRH node, a network-controlled repeater (NCR) node, etc.) a sensing-dedicated sensing node, a low-power sensor device, or combinations thereof. In implementations, a dedicated sensor node can be interpreted as a unit and/or entity for which a user-plane traffic to a network includes sensing related information. For instance, a dedicated sensor node may not be connected to the network (e.g., does not implement an RRC connected state), but control and/or sensing data from the dedicated sensing node can be communicated to the dedicated sensing node via a second sensing node where the second sensing device communicated to the network in the connected state, e.g., RRC connected state. For instance, the sensing capability of a sensing node and/or a sensing related information of a sensing node (e.g., including RAT-dependent and/or RAT-independent sensing capability information) can be reported to the network, such as autonomously and/or upon network request.

In implementations, the capability information of a sensing node for sensing includes the capability of obtaining sensing and/or environment-related information via RAT-independent technologies. For instance, the sensing capability information includes, but not limited to:
a) Sensing node and/or sensor device location, orientation, movement and/or velocity patterns;
b) Sensing activation latency, e.g., a time-delay between sensing node and/or device activation and/or start of a sensing measurement and/or sensing information acquisition process and a received indication for sensing activation and/or sensing measurement configuration;
c) Sensing reporting latency, e.g., supported reporting latency of a sensing measurement, such as from the reception of a request;
d) Type of the supported/available sensing technology, e.g., RGB camera, Lidar, RGB depth (RGBD) camera, Radar, Infrared camera, acoustics sensor, etc., RF signal measurements based on GNSS signals, RF signal measurements based on Bluetooth signals, RF signal measurements based on WiFi signals, etc.;
e) Supported sensing information type, e.g., Bitmap image of an RGB camera, bitmap image of RGBD camera, etc.;
f) Supported sensing information resolution and/or accuracy: e.g., supported resolution of angular/spatial separation, e.g., bitmap resolution/dpi of an RGB/RGBD camera; supported resolution and/or accuracy of the sensing information, e.g., a number of bits defining each pixel of an RGB/RGBD reading, RoC of object detection (e.g., supported detection/false alarm probability of object detection) via a radar technology;
g) Supported (absolute/relative) area of sensing, e.g., an angular range of the azimuth and/or elevation domain according to a local or globally known coordinate system;
h) State of a sensing node, e.g., a power-off state, a low-battery state, low storage state, low computational resource state.

In implementations a combination of the above indications can be utilized to define a capability information. For instance, the indicated capability can include an available information type associated with a sensor technology, an associated latency, a supported angular coverage and resolution, etc., associated with the sensor information type of the sensor technology. In at least one example, a sensor resolution and/or latency can be indicated for a first part of an indicated angular and/or spatial coverage of a sensor data type, and a second sensor resolution and/or latency can be indicated for a second part of an indicated angular and/or spatial coverage of a sensor data type. For instance, multiple capability indications can be transmitted by a sensing node defining different capability descriptions of different sensor types and/or sensor technologies.

In implementations a first capability information is indicated and/or associated with a first sensor node state, and a second capability information is indicated associated with a second sensor node state. For instance, low resolution sensing capability can be indicated for a sensing data type (e.g., RGB bitmap image) during a sensing node low-battery state, and a high-resolution sensing capability can be indicated for a sensing data type during a sensing node normal-power state. Further, a joint capability can be indicated for multiple sensor nodes and/or a sensor group.

In implementations sensor capability information can be reported to a sensing management entity. The sensing management entity, for instance, is part of a RAN, e.g., a gNB or part of a UE. In at least one example, a UE identifies surrounding sensing nodes and obtains sensing capability information of the surrounding sensing nodes (e.g., via physical sidelink channel resources with a priori indicated configuration by the network) and accordingly can configure the sensing measurement of the sensing nodes. In implementations a gNB can obtain sensing capability of UEs such as including RAT-independent sensing capability information and can accordingly configure measurement and acquisition of sensing information.

In implementations, the sensing management entity can be located in the core network, and the sensing management entity can obtain sensing capability information (e.g., including non-RAT-dependent sensing capability) of one or more RAN nodes (e.g., gNB and IAB node), one or more UE devices, one or more sensing-dedicated sensor devices, etc. In implementations, sensing-dedicated sensor devices (e.g., a camera, a motion sensor, etc.) can communicate with the sensing management entity of the network for reception of sensing configuration and/or sensing measurement reporting via the NAS. In implementations, the sensing-dedicated sensor devices can be connected to the core network via a dedicated interface for sensing-dedicated devices.

In implementations, sensing capability information of a sensing node can be indicated via an index of a codebook, where the codebook includes pre-defined categories of sensor technologies and associated capabilities. For instance, an index “1” can correspond to a capability indication of a sensor device via an RGB camera, with latency of sensing activation of at most 1 ms for angular displacement of up to 60 degrees of elevation and of at most 45 degrees of azimuth and sensing information resolution of 2 k dpi. In implementations, multiple indices can be indicated simultaneously to define a combined and/or superimposed capability. Further, RAT-independent capability of sensing nodes can be indicated via a codebook defining the RAT-independent sensing capabilities.

In implementations, the configuration of a sensing activation and/or sensing measurement configuration of a sensing node can be accompanied with an indication of sensing, e.g., configuration of an RSRP with an indicated beam and/or beam parameters at a UE and/or gNB, with the indication that the RSRP is measured for sensing.

In implementations, upon configuration of a sensing node with a sensing measurement, the sensing node may, based on prior configuration of the network, indicate one or more of:
a) An existence of a non-RAT dependent sensing information at the sensing node related to the configured RAT-dependent sensing measurement, e.g., availability of a camera reading at a specified angle related to the RSRP measurement, according to the configured sensing measurement timing and/or Rx beam;
b) A capability of obtaining a non-RAT dependent sensing information at the sensing node related to the configured RAT-dependent sensing measurement, e.g., capability of camera reading at a specified angle related to the configured RSRP measurement, according to the configured sensing measurement timing and/or Rx beam;
c) A related non-RAT dependent sensing measurement, e.g., including in a sensing measurement report the camera reading at a specified angle related to the configured RSRP measurement, according to the configured sensing measurement timing and/or Rx beam.

In implementations, tasks such as a determination and/or configuration of a logical sensor and/or sensor group association of a logical sensor to a sensing task (examples of a sensing task include determination of presence of an object (e.g., human) in an observation area, estimation of the velocity of an object, etc.), the configuration of sensing activation, sensing measurement resources, sensing measurement type and/or configuration, sensing reporting, and combinations thereof by the network can be performed, at least in part, according to the a priori indicated RAT-dependent and/or RAT-independent sensing capability information.

In implementations, the configuration of a sensing node for sensing includes indication of a sensor group ID, a logical sensor ID, and a sensing type ID and combinations thereof. Further, sensing activation, measurement, reporting, and combinations thereof of a sensing node can be done at least based on association of the sensing node to the logical sensor ID, sensor group ID, the sensing measurement type ID, and combinations thereof.

In implementations, a sensing management entity can configure the sensing nodes (e.g., dedicated sensing nodes but not precluding sensing UEs and/or TRPs, such as according to their capability indications) which are capable of sensing and/or monitoring a first desired area of a road (e.g., are located within 3m-radius of the first desired road segment to be monitored) into a first logical sensor, for which a first logical sensor ID is assigned; and the sensing nodes in the 3-m radius of a second desired part of the road to a second logical sensor, for which a second logical sensor ID is assigned. The sensing nodes belonging to the first configured logical sensor can be indicated with a beam directed to the first road segment and the sensing nodes belonging to the second configured logical sensor can be indicated with a beam directed to the second road segment a coordinate system known to the sensing nodes of a logical sensor. Moreover, each logical sensor can be configured with one or more RAT-dependent and/or RAT-independent sensing measurement types. Upon the acquisition of the configured sensing measurements, the logical sensors can report to the network and/or sensing management entity sensing data pertaining to object (e.g., vehicles) observed at the different road segments. The sensing management entity can generate an indication of the road status based on the reported sensing measurements of the logical sensors.

In implementations, a sensor group can be determined as a group of sensing nodes belonging to at least one of the configured logical sensors among multiple logical sensors, such as for which a sensor group ID is assigned and indicated to each sensing node and/or logical sensor. In examples, a sensing node within a sensor group may be assigned to two or multiple logical sensors. As such, the activation and/or deactivation of a group of sensing nodes (e.g., including multiple logical sensors), all or part of a reporting configuration (e.g., reporting periodicity, reporting measurement type, etc.) can be jointly configured for the sensing nodes within a sensor group.

In implementations one sensing node may be associated to one or multiple logical sensors and/or one or multiple sensing measurement types. In implementations a request for capability information of a sensing node, request for a RAT-independent sensing information, configuration or sensing measurement, configuration of a sensing node and/or a sensor group, sensing node report of sensing measurements, sensing node report of RAT-independent sensing information, sensing node capability description of RAT-dependent and RAT-independent sensing technologies at a sensing node, and combinations thereof, can be communicated between the network and the sensing node via one or more of a physical DL channel of the wireless network (e.g., PDCCH, PDSCH), a physical UL channel of the wireless network (e.g. PUCCH, PUSCH), a physical sidelink (SL) channel, a higher layer NAS signaling (e.g., LTE positioning protocol (LPP) signaling utilized for sensing capability indication), and combinations thereof.

In implementations an entity that requests sensing capability information, an entity that requests sensing information, an entity that configures sensing measurements of a sensing node, and/or an entity that receives a sensing report of sensing measurements and/or sensing information may be different entities, including instances of a core network entity, a RAN node, a UE, an application server, etc., such as utilizing a 3GPP network for connectivity, group discovery and sensing information acquisition.

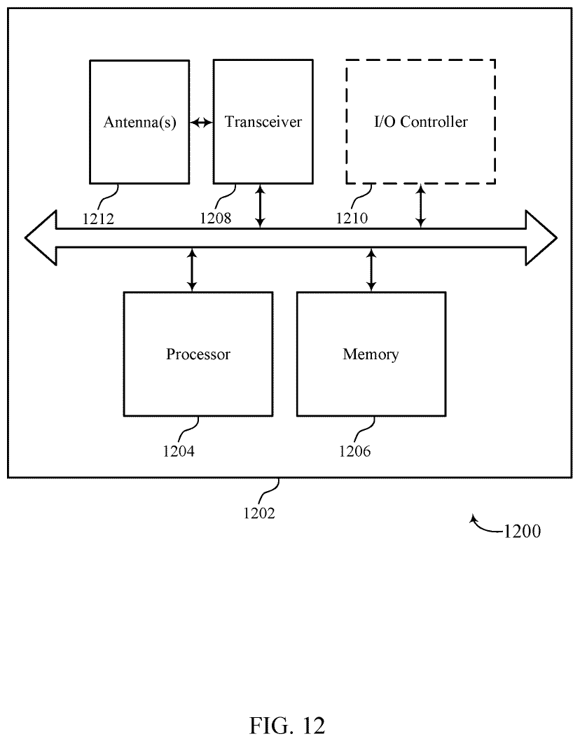

FIG. 12 illustrates an example of a block diagram 1200 of a device 1202 (e.g., an apparatus) that supports sensor network capability determination in accordance with aspects of the present disclosure. The device 1202 may be an example of sensing node (e.g., a UE 104) as described herein. The device 1202 may support wireless communication with one or more network entities 102, UEs 104, or any combination thereof. The device 1202 may include components for bi-directional communications including components for transmitting and receiving communications, such as a processor 1204, a memory 1206, a transceiver 1208, and an I/O controller 1210. These components may be in electronic communication or otherwise coupled (e.g., operatively, communicatively, functionally, electronically, electrically) via one or more interfaces (e.g., buses).

The processor 1204, the memory 1206, the transceiver 1208, or various combinations thereof or various components thereof may be examples of means for performing various aspects of the present disclosure as described herein. For example, the processor 1204, the memory 1206, the transceiver 1208, or various combinations or components thereof may support a method for performing one or more of the operations described herein.

In some implementations, the processor 1204, the memory 1206, the transceiver 1208, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1204 and the memory 1206 coupled with the processor 1204 may be configured to perform one or more of the functions described herein (e.g., executing, by the processor 1204, instructions stored in the memory 1206). In the context of UE 104, for example, the transceiver 1208 and the processor coupled 1204 coupled to the transceiver 1208 are configured to cause the UE 104 to perform the various described operations and/or combinations thereof.

For example, the processor 1204 and/or the transceiver 1208 may support wireless communication at the device 1202 in accordance with examples as disclosed herein. For instance, the processor 1204 and/or the transceiver 1208 may be configured as and/or otherwise support a means to receive configuration signaling including sensing activation and sensing configuration information; collect measurement signals and perform a sensing task based at least in part on a sensing reference determined from the sensing configuration information to generate a sensing output signal; and transmit a sensing report indicating a function of at least one of the sensing output signal or a sensing event detected based at least in part on the sensing output signal.

Further, in some implementations, the processor 1204 and/or the transceiver 1208 may be configured as and/or otherwise support a means to transmit the sensing report over a set of physical radio resources allocated based at least in part on the sensing configuration information; the physical radio resources include one or more of time resources, frequency resources, or space resources; the physical radio resources are pre-allocated to the apparatus by a network entity as part of the sensing configuration information; a first subset of the physical radio resources are pre-allocated as part of the sensing configuration information and a second subset of the physical radio resources are dynamically post-allocated based on at least a first portion of the sensing report; the apparatus includes a sensing node of a logical sensor including a group of sensing nodes; the sensing configuration information includes an indication defining the group of sensing nodes; the sensing configuration information includes an indication that the apparatus is a primary sensing node of the logical sensor

Further, in some implementations, the processor 1204 and/or the transceiver 1208 may be configured as and/or otherwise support a means to collect sensing reports from sensing nodes that include the logical sensor; the processor is configured to cause the apparatus to: generate the sensing report to include an aggregated sensing report from one or more sensing nodes of the logical sensor; and transmit the sensing report to a network entity; a first portion of the sensing report includes an indication of one or more sensing nodes that detect the sensing event based at least in part on the sensing configuration information; the indication includes a bitmap representation of bits, with each bit of the bits corresponding to one or more of an enabled sensing node and an enabled logical sensor including a group of sensing nodes, as indicated by the sensing configuration information, and a zero bit report indicates that the sensing event is not detected and a one bit report indicates that the sensing event is detected by at least one of a sensing node or a logical sensor, wherein a logical sensor includes a group of sensing nodes

Further, in implementations a second portion of the sensing report includes a representation of groups of bits, wherein represents a number of detected sensing events based on the first portion of the sensing report, and wherein each subgroup of bits of the group of bits corresponds to an indication of the one or more sensing nodes or the logical sensor that detects the sensing event; the indication of the one or more sensing nodes that detect the sensing event includes, for each of one of an enabled sensing node or an enabled logical sensor among sensing nodes or logical sensors that detect the sensing event, at least one of: a bitmap of fixed length, wherein each bit of the bitmap corresponds to each of one or more sensing nodes enabled and indicated by the sensing configuration information; a combinatorial dynamic length group of bits encoding each combination of sensing nodes that detect the sensing event out of a total sensing nodes; or a compressed representation of a combinatorial dynamic length group of bits of at most bits, wherein the compressed representation encodes a combination of sensing nodes that detect the sensing event out of a total sensing nodes.

Further, in implementations a third portion of the sensing report includes a representation of a set of one or more sensing parameters reports, and each sensing parameters report maps to an encoding of the sensing output signal of a corresponding sensing node; a number of the one or more sensing parameters reports included in the third portion of the sensing report is based at least in part on the one or more sensing nodes that detect the sensing event as indicated based on at least the first portion and the second portion of the sensing report; at least one sensing parameters report of the set of one or more sensing parameters reports includes of at least one of: a channel state information (CSI) parameter estimation; a reference signal received power (RSRP) parameter estimation; a beam index parameter estimation; a beam management parameter estimation; an angular parameter estimation including of one of an angle of arrival (AoA) or an angle of departure (AoD) parameter estimation; a signal strength parameter estimation including of one of a signal-to-interference-noise ratio (SINR) or a signal-to-noise ratio (SNR) parameter estimation; a channel rank parameter estimation; a signal multiple path propagation parameter estimation; or a signal propagation blockage detection parameter estimation; the sensing reference is based at least in part on a radio-frequency sensing reference signal, wherein an origin of the radio-frequency sensing reference signal is one of internal with respect to the apparatus or external with respect to the apparatus; the sensing reference is based on at least one of a sensing reference signal or a sensing reference inference model.

Further, the processor 1204 and/or the transceiver 1208 may support wireless communication at the device 1202 in accordance with examples as disclosed herein. For instance, the processor 1204 and/or the transceiver 1208 may be configured as and/or otherwise support a means to receive a configuration signaling including sensing activation and sensing configuration information; collect measurement signals and performing a sensing task based at least in part on a sensing reference determined from the sensing configuration information to generate a sensing output signal; and transmit a sensing report indicating a function of at least one of the sensing output signal or a sensing event detected based at least in part on the sensing output signal, the sensing report including: a first portion including an indication of one or more sensing nodes that detect the sensing event; a second portion including a number of detected sensing events based at least in part on the first portion of the sensing report; and a third portion including a representation of a set of one or more sensing parameters reports.

Further, in some implementations, the processor 1204 and/or the transceiver 1208 may be configured as and/or otherwise support a means to determine the sensing reference via at least one of a sensing reference signal or a sensing reference inference model.

In a further example, the processor 1204 and/or the transceiver 1208 may support wireless communication at the device 1202 in accordance with examples as disclosed herein. The processor 1204 and/or the transceiver 1208, for instance, may be configured as or otherwise support a means for receiving configuration signaling including sensing activation and sensing configuration information; collecting measurement signals and perform a sensing task based at least in part on a sensing reference determined from the sensing configuration information to generate a sensing output signal; and transmitting a sensing report indicating a function of at least one of the sensing output signal or a sensing event detected based at least in part on the sensing output signal.

Further, in some implementations, processor 1204 and/or the transceiver 1208, for instance, may be configured as or otherwise support a means for transmitting the sensing report over a set of physical radio resources allocated based at least in part on the sensing configuration information; the physical radio resources include one or more of time resources, frequency resources, or space resources; the physical radio resources are pre-allocated by a network entity as part of the sensing configuration information; a first subset of the physical radio resources are pre-allocated as part of the sensing configuration information and a second subset of the physical radio resources are dynamically post-allocated based on at least a first portion of the sensing report; the method is performed by a sensing node of a logical sensor including a group of sensing nodes; the sensing configuration information includes an indication defining the group of sensing nodes; the sensing configuration information includes an indication that the sensing node is a primary sensing node of the logical sensor, and the method further includes collecting sensing reports from sensing nodes that include the logical sensor; generating the sensing report to include an aggregated sensing report from one or more sensing nodes of the logical sensor; and transmitting the sensing report to a network entity.

Further, in implementations a first portion of the sensing report includes an indication of one or more sensing nodes that detect the sensing event based at least in part on the sensing configuration information; the indication includes a bitmap representation of bits, with each bit of the bits corresponding to one or more of an enabled sensing node and an enabled logical sensor including a group of sensing nodes, as indicated by the sensing configuration information, and a zero bit report indicates that the sensing event is not detected and a one bit report indicates that the sensing event is detected by at least one of a sensing node or a logical sensor, a logical sensor includes a group of sensing nodes; a second portion of the sensing report includes a representation of groups of bits, represents a number of detected sensing events based on the first portion of the sensing report, and each subgroup of bits of the group of bits corresponds to an indication of the one or more sensing nodes or the logical sensor that detects the sensing event; the indication of the one or more sensing nodes that detect the sensing event includes, for each of one of an enabled sensing node or an enabled logical sensor among sensing nodes or logical sensors that detect the sensing event, at least one of: a bitmap of fixed length, each bit of the bitmap corresponds to each of one or more sensing nodes enabled and indicated by the sensing configuration information; a combinatorial dynamic length group of bits encoding each combination of sensing nodes that detect the sensing event out of a total sensing nodes; or a compressed representation of a combinatorial dynamic length group of bits of at most bits.

Further, in implementations the compressed representation encodes a combination of sensing nodes that detect the sensing event out of a total sensing nodes; a third portion of the sensing report includes a representation of a set of one or more sensing parameters reports, and each sensing parameters report maps to an encoding of the sensing output signal of a corresponding sensing node; a number of the one or more sensing parameters reports included in the third portion of the sensing report is based at least in part on the one or more sensing nodes that detect the sensing event as indicated based on at least the first portion and the second portion of the sensing report; at least one sensing parameters report of the set of one or more sensing parameters reports includes of at least one of: a channel state information (CSI) parameter estimation; a reference signal received power (RSRP) parameter estimation; a beam index parameter estimation; a beam management parameter estimation; an angular parameter estimation including of one of an angle of arrival (AoA) or an angle of departure (AoD) parameter estimation; a signal strength parameter estimation including of one of a signal-to-interference-noise ratio (SINR) or a signal-to-noise ratio (SNR) parameter estimation; a channel rank parameter estimation; a signal multiple path propagation parameter estimation; or a signal propagation blockage detection parameter estimation; the sensing reference is based at least in part on a radio-frequency sensing reference signal, an origin of the radio-frequency sensing reference signal is one of internal with respect to an apparatus the performs the method or external with respect to the apparatus; the sensing reference is based on at least one of a sensing reference signal or a sensing reference inference model.

In a further example, the processor 1204 and/or the transceiver 1208 may support wireless communication at the device 1202 in accordance with examples as disclosed herein. The processor 1204 and/or the transceiver 1208, for instance, may be configured as or otherwise support a means for receiving a configuration signaling including sensing activation and sensing configuration information; collecting measurement signals and performing a sensing task based at least in part on a sensing reference determined from the sensing configuration information to generate a sensing output signal; and transmitting a sensing report indicating a function of at least one of the sensing output signal or a sensing event detected based at least in part on the sensing output signal, the sensing report including: a first portion including an indication of one or more sensing nodes that detect the sensing event; a second portion including a number of detected sensing events based at least in part on the first portion of the sensing report; and a third portion including a representation of a set of one or more sensing parameters reports.

Further, in some implementations, processor 1204 and/or the transceiver 1208, for instance, may be configured as or otherwise support a means for determining the sensing reference via at least one of a sensing reference signal or a sensing reference inference model.

Further, the processor 1204 and/or the transceiver 1208 may support wireless communication at the device 1202 in accordance with examples as disclosed herein. For instance, the processor 1204 and/or the transceiver 1208 may be configured as and/or otherwise support a means to transmit, to a sensing management entity, sensing capability information including radio access technology (RAT)-dependent sensing capability information and RAT-independent sensing capability information; receive, based at least in part on the sensing capability information, configuration information including RAT-dependent sensing information and RAT-independent sensing information; generate, based at least in part on the configuration information, one or more sensing measurements; and transmit a sensing report including the one or more sensing measurements.

Further, in some implementations, the processor is configured to cause the apparatus to: receive a request for one or more of RAT-dependent sensing capability information or RAT-independent sensing capability information; and transmit the sensing capability information based at least in part on the request; the sensing capability information includes one or more of: a sensing activation latency; a sensing information refresh rate including a minimum time that one or more of a sensing measurement or sensing information is one or more of repeatable or refreshable; a sensing reporting latency; a type of supported or available RAT-independent sensing; a supported sensing information type via RAT-independent sensing; a type of supported or available RAT-dependent sensing; a supported sensing information type via RAT-dependent sensing; one or more of a supported sensing information resolution or a supported sensing information accuracy; one or more of a supported absolute area of sensing or a supported relative area of sensing; or a state of one or more sensing nodes associated with the sensing capability information.

Further, in some implementations, the sensing capability information includes a first sensing capability for a first indicated sensing area and a second sensing capability for a second indicated sensing area; the sensing capability information is indicated via an index from a codebook, and wherein the codebook includes defined sensing capability characteristics of a sensing node; the processor is configured to cause the apparatus to: receive a request for one or more of RAT-dependent measurement configuration, including an indication for sensing and/or sensing information type; determine one or more of an availability or a capability to obtain a RAT-independent sensing information related to the received configuration of the RAT-dependent measurement; and transmit an indication of the one or more of the availability or the capability of a RAT-independent sensing information related to the received configuration of the RAT-dependent measurement; upon transmission of the capability information to obtain RAT independent sensing information, related to a RAT dependent measurement configuration, the processor is configured to cause the apparatus to: receive a request for reporting the RAT independent sensing information; obtain the requested RAT independent sensing information; and transmit a report on the obtained RAT independent sensing information.

In a further example, the processor 1204 and/or the transceiver 1208 may support wireless communication at the device 1202 in accordance with examples as disclosed herein. The processor 1204 and/or the transceiver 1208, for instance, may be configured as or otherwise support a means for transmitting, to a sensing management entity, sensing capability information including radio access technology (RAT)-dependent sensing capability information and RAT-independent sensing capability information; receiving, based at least in part on the sensing capability information, configuration information including RAT-dependent sensing information and RAT-independent sensing information; generating, based at least in part on the configuration information, one or more sensing measurements; and transmitting a sensing report including the one or more sensing measurements.

Further, in some implementations, processor 1204 and/or the transceiver 1208, for instance, may be configured as or otherwise support a means for receiving a request for one or more of RAT-dependent sensing capability information or RAT-independent sensing capability information; and transmitting the sensing capability information based at least in part on the request; wherein the sensing capability information includes one or more of: a sensing activation latency; a sensing information refresh rate including a minimum time that one or more of a sensing measurement or sensing information is one or more of repeatable or refreshable; a sensing reporting latency; a type of supported or available RAT-independent sensing; a supported sensing information type via RAT-independent sensing; a type of supported or available RAT-dependent sensing; a supported sensing information type via RAT-dependent sensing; one or more of a supported sensing information resolution or a supported sensing information accuracy; one or more of a supported absolute area of sensing or a supported relative area of sensing; or a state of one or more sensing nodes associated with the sensing capability information.

Further, in some implementations the sensing capability information includes a first sensing capability for a first indicated sensing area and a second sensing capability for a second indicated sensing area; wherein the sensing capability information is indicated via an index from a codebook, and wherein the codebook includes defined sensing capability characteristics of a sensing node; further including: receiving a request for one or more of RAT-dependent measurement configuration, including an indication for sensing and/or sensing information type; determining one or more of an availability or a capability to obtain a RAT-independent sensing information related to the received configuration of the RAT-dependent measurement; and transmitting an indication of the one or more of the availability or the capability of a RAT-independent sensing information related to the received configuration of the RAT-dependent measurement; wherein upon transmission of the capability information to obtain RAT independent sensing information, related to a RAT dependent measurement configuration, the method further includes: receiving a request for reporting the RAT independent sensing information; obtaining the requested RAT independent sensing information; and transmitting a report on the obtained RAT independent sensing information.

The processor 1204 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1204 may be configured to operate a memory array using a memory controller. In some other implementations, a memory controller may be integrated into the processor 1204. The processor 1204 may be configured to execute computer-readable instructions stored in a memory (e.g., the memory 1206) to cause the device 1202 to perform various functions of the present disclosure.

The memory 1206 may include random access memory (RAM) and read-only memory (ROM). The memory 1206 may store computer-readable, computer-executable code including instructions that, when executed by the processor 1204 cause the device 1202 to perform various functions described herein. The code may be stored in a non-transitory computer-readable medium such as system memory or another type of memory. In some implementations, the code may not be directly executable by the processor 1204 but may cause a computer (e.g., when compiled and executed) to perform functions described herein. In some implementations, the memory 1206 may include, among other things, a basic I/O system (BIOS) which may control basic hardware or software operation such as the interaction with peripheral components or devices.

The I/O controller 1210 may manage input and output signals for the device 1202. The I/O controller 1210 may also manage peripherals not integrated into the device M02. In some implementations, the I/O controller 1210 may represent a physical connection or port to an external peripheral. In some implementations, the I/O controller 1210 may utilize an operating system such as iOS®, ANDROID®, MS-DOS®, MS-WINDOWS®, OS/2®, UNIX®, LINUX®, or another known operating system. In some implementations, the I/O controller 1210 may be implemented as part of a processor, such as the processor M08. In some implementations, a user may interact with the device 1202 via the I/O controller 1210 or via hardware components controlled by the I/O controller 1210.

In some implementations, the device 1202 may include a single antenna 1212. However, in some other implementations, the device 1202 may have more than one antenna 1212 (e.g., multiple antennas), including multiple antenna panels or antenna arrays, which may be capable of concurrently transmitting or receiving multiple wireless transmissions. The transceiver 1208 may communicate bi-directionally, via the one or more antennas 1212, wired, or wireless links as described herein. For example, the transceiver 1208 may represent a wireless transceiver and may communicate bi-directionally with another wireless transceiver. The transceiver 1208 may also include a modem to modulate the packets, to provide the modulated packets to one or more antennas 1212 for transmission, and to demodulate packets received from the one or more antennas 1212.

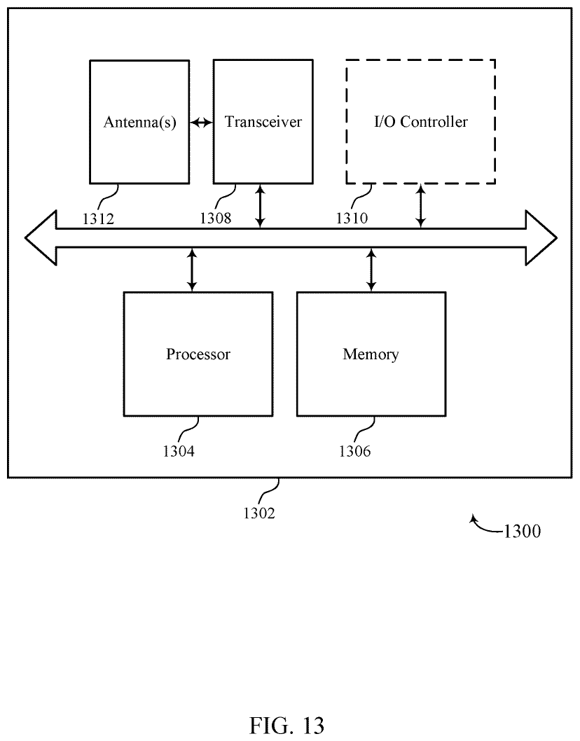

FIG. 13 illustrates an example of a block diagram 1300 of a device 1302 (e.g., an apparatus) that supports sensor network capability determination in accordance with aspects of the present disclosure. The device 1302 may be an example of a sensing configuration node (e.g., a network entity 102) as described herein. The device 1302 may support wireless communication with one or more network entities 102, UEs 104, or any combination thereof. The device 1302 may include components for bi-directional communications including components for transmitting and receiving communications, such as a processor 1304, a memory 1306, a transceiver 1308, and an I/O controller 1310. These components may be in electronic communication or otherwise coupled (e.g., operatively, communicatively, functionally, electronically, electrically) via one or more interfaces (e.g., buses).

The processor 1304, the memory 1306, the transceiver 1308, or various combinations thereof or various components thereof may be examples of means for performing various aspects of the present disclosure as described herein. For example, the processor 1304, the memory 1306, the transceiver 1308, or various combinations or components thereof may support a method for performing one or more of the operations described herein.

In some implementations, the processor 1304, the memory 1306, the transceiver 1308, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1304 and the memory 1306 coupled with the processor 1304 may be configured to perform one or more of the functions described herein (e.g., executing, by the processor 1304, instructions stored in the memory 1306). In the context of network entity 102, for example, the transceiver 1308 and the processor 1304 coupled to the transceiver 1308 are configured to cause the network entity 102 to perform the various described operations and/or combinations thereof.

For example, the processor 1304 and/or the transceiver 1308 may support wireless communication at the device 1302 in accordance with examples as disclosed herein. For instance, the processor 1304 and/or the transceiver 1308 may be configured as or otherwise support a means to For example, the processor 1304 and/or the transceiver 1308 may support wireless communication at the device 1302 in accordance with examples as disclosed herein. For instance, the processor 1304 and/or the transceiver 1308 may be configured as and/or otherwise support a means to transmit configuration signaling to a set of sensing nodes, the configuration signaling including at least two parts: a first part of the configuration signaling including an activation message to the set of sensing nodes configured to activate at least a subset of the set of sensing nodes; and a second part of the configuration signaling including sensing configuration information corresponding to the at least a subset of the set of sensing nodes; and receive one or more sensing reports from the at least a subset of the set of sensing nodes and based at least in part on the configuration signaling.

Further, in some implementations, the activation message includes one or more of sensing on or sensing off information for the set of sensing nodes; the activation message is common across the set of sensing nodes; the activation message is in a form of a bitmap with each sensing node of the set of sensing nodes corresponding to a respective bit of the bitmap; the second part of the configuration signaling includes at least one of time-domain information, frequency-domain information, spatial-domain information, or location information corresponding to the at least a subset of the set of sensing nodes; each sensing node of the set of the sensing nodes is mapped to at least one logical sensor node of a group of one or more logical sensors; the configuration signaling includes a mapping of each sensing node of the set of sensing nodes to the group of one or more logical sensors; at least one sensing node of the set of the sensing nodes is mapped to a plurality of logical sensors of the group of the one or more logical sensors.

Further, in some implementations, the configuration signaling includes an indication of physical uplink resources to be used for the one or more sensing reports over a physical uplink channel, and the physical uplink resources correspond to one or more of time-domain resources, frequency-domain resources, or a pair of time-domain and frequency-domain resources; one or more fields of the sensing report include a repetition of values of a given parameter if a number of the physical uplink resources is larger than a threshold value that is based on a number of activated sensing nodes; the processor is configured to cause the apparatus to transmit a set of beams to the set of sensing nodes; the one or more sensing reports include an indication of a beam from the set of beams associated with each sensing node of the set of sensing nodes; the set of beams correspond to one or more of a plurality of channel state information reference signal (CSI-RS) resources or a sensing-based reference signal

In a further example, the processor 1304 and/or the transceiver 1308 may support wireless communication at the device 1302 in accordance with examples as disclosed herein. The processor 1304 and/or the transceiver 1308, for instance, may be configured as or otherwise support a means to group sensor nodes of a set of sensor nodes into different groups of logical sensors; transmit configuration signaling to at least one group of logical sensors, the configuration signaling including an activation message activating the at least one group of logical sensors and sensing configuration information corresponding to the at least one group of logical sensors; and receive one or more sensing reports from the at least one group of logical sensors and based at least in part on the configuration signaling.

Further, in some implementations, the processor and the transceiver are configured such that to group the sensor nodes of the set of sensor nodes, the processor is configured to cause the apparatus to map a first sensor node of the set of sensor nodes to a plurality of groups of logical sensors; the configuration signaling includes a mapping indicating a grouping of the set of sensor nodes into the different groups of logical sensors.

In a further example, the processor 1304 and/or the transceiver 1308 may support wireless communication at the device 1302 in accordance with examples as disclosed herein. The processor 1304 and/or the transceiver 1308, for instance, may be configured as or otherwise support a means to transmit a set of beams to a set of sensor nodes; receive, from each sensor node of the set of sensor nodes, a beam report associated with at least one beams of the set of beams; generate, based at least in part on the beam report from each sensor node of the set of sensor nodes, a sensor map that maps individual sensor nodes of the set of sensor nodes with respective beams of the set of beams; and receive sensing reports from the set of sensor nodes and via beams associated with the set of sensor nodes.

Further, in some implementations, the processor and the transceiver are configured such that each sensing report includes an indication of a beam associated with a sensing node that transmits the sensing report; the set of beams correspond to one or more of a plurality of channel state information reference signal (CSI-RS) resources or a sensing-based reference signal.

In a further example, the processor 1304 and/or the transceiver 1308 may support wireless communication at the device 1302 in accordance with examples as disclosed herein. The processor 1304 and/or the transceiver 1308, for instance, may be configured as or otherwise support a means for transmitting configuration signaling to a set of sensing nodes, the configuration signaling including at least two parts: a first part of the configuration signaling including an activation message to the set of sensing nodes configured to activate at least a subset of the set of sensing nodes; and a second part of the configuration signaling including sensing configuration information corresponding to the at least a subset of the set of sensing nodes; and receiving one or more sensing reports from the at least a subset of the set of sensing nodes and based at least in part on the configuration signaling.

Further, in some implementations, activation message includes one or more of sensing on or sensing off information for the set of sensing nodes; the activation message is common across the set of sensing nodes; the activation message is in a form of a bitmap with each sensing node of the set of sensing nodes corresponding to a respective bit of the bitmap; the second part of the configuration signaling includes at least one of time-domain information, frequency-domain information, spatial-domain information, or location information corresponding to the at least a subset of the set of sensing nodes; each sensing node of the set of the sensing nodes is mapped to at least one logical sensor node of a group of one or more logical sensors; the configuration signaling includes a mapping of each sensing node of the set of sensing nodes to the group of one or more logical sensors.

Further, implementations at least one sensing node of the set of the sensing nodes is mapped to a plurality of logical sensors of the group of the one or more logical sensors; the configuration signaling includes an indication of physical uplink resources to be used for the one or more sensing reports over a physical uplink channel, and the physical uplink resources correspond to one or more of time-domain resources, frequency-domain resources, or a pair of time-domain and frequency-domain resources; one or more fields of the sensing report include a repetition of values of a given parameter if a number of the physical uplink resources is larger than a threshold value that is based on a number of activated sensing nodes; further including transmit a set of beams to the set of sensing nodes; the one or more sensing reports include an indication of a beam from the set of beams associated with each sensing node of the set of sensing nodes; the set of beams correspond to one or more of a plurality of channel state information reference signal (CSI-RS) resources or a sensing-based reference signal.

In a further example, the processor 1304 and/or the transceiver 1308 may support wireless communication at the device 1302 in accordance with examples as disclosed herein. The processor 1304 and/or the transceiver 1308, for instance, may be configured as or otherwise support a means for grouping sensor nodes of a set of sensor nodes into different groups of logical sensors; transmitting configuration signaling to at least one group of logical sensors, the configuration signaling including an activation message activating the at least one group of logical sensors and sensing configuration information corresponding to the at least one group of logical sensors; and receiving one or more sensing reports from the at least one group of logical sensors and based at least in part on the configuration signaling.

Further, in some implementations, grouping the sensor nodes of the set of sensor nodes includes mapping a first sensor node of the set of sensor nodes to a plurality of groups of logical sensors; the configuration signaling includes a mapping indicating a grouping of the set of sensor nodes into the different groups of logical sensors.

In a further example, the processor 1304 and/or the transceiver 1308 may support wireless communication at the device 1302 in accordance with examples as disclosed herein. The processor 1304 and/or the transceiver 1308, for instance, may be configured as or otherwise support a means for transmitting a set of beams to a set of sensor nodes; receiving, from each sensor node of the set of sensor nodes, a beam report associated with at least one beams of the set of beams; generating, based at least in part on the beam report from each sensor node of the set of sensor nodes, a sensor map that maps individual sensor nodes of the set of sensor nodes with respective beams of the set of beams; and receiving sensing reports from the set of sensor nodes and via beams associated with the set of sensor nodes.

Further, in some implementations, each sensing report includes an indication of a beam associated with a sensing node that transmits the sensing report; the set of beams correspond to one or more of a plurality of channel state information reference signal (CSI-RS) resources or a sensing-based reference signal.

In a further example, the processor 1304 and/or the transceiver 1308 may support wireless communication at the device 1302 in accordance with examples as disclosed herein. The processor 1304 and/or the transceiver 1308, for instance, may be configured as or otherwise support a means to transmit a configuration signaling including sensing activation and sensing configuration information of a sensing task to one or more sensing nodes; receive one or more sensing reports from the one or more sensing nodes based in part on the sensing task and output of the one or more sensing nodes sensing, the one or more sensing reports including: a first portion including an indication of one or more sensing nodes that detect a sensing event; a second portion including a number of detected sensing events based at least in part on the first portion of the sensing report; and a third portion including a representation of a set of one or more sensing parameters reports; and aggregate the received sensing reports based in part on the sensing task.

In a further example, the processor 1304 and/or the transceiver 1308 may support wireless communication at the device 1302 in accordance with examples as disclosed herein. The processor 1304 and/or the transceiver 1308, for instance, may be configured as or otherwise support a means for transmitting a configuration signaling including sensing activation and sensing configuration information of a sensing task to one or more sensing nodes; receiving one or more sensing reports from the one or more sensing nodes based in part on the sensing task and output of the one or more sensing nodes sensing, the one or more sensing reports including: a first portion including an indication of one or more sensing nodes that detect a sensing event; a second portion including a number of detected sensing events based at least in part on the first portion of the sensing report; and a third portion including a representation of a set of one or more sensing parameters reports; and aggregating the received sensing reports based in part on the sensing task.

For example, the processor 1304 and/or the transceiver 1308 may support wireless communication at the device 1302 in accordance with examples as disclosed herein. For instance, the processor 1304 and/or the transceiver 1308 may be configured as and/or otherwise support a means to receive, from one or more sensing nodes, sensing capability information including radio access technology (RAT)-dependent sensing capability information and RAT-independent sensing capability information; generate, based at least in part on the sensing capability information, configuration information including one or more of RAT-dependent sensing information or RAT-independent sensing information; and transmit, to the one or more sensing nodes, the configuration information.

Further, in some implementations, the processor is configured to cause the apparatus to generate the configuration information to include an association of the one or more sensing nodes with at least one of one or more sensor groups or one or more logical sensors; a sensor group of the one or more sensor groups corresponds to a logical sensor of the one or more logical sensors, and wherein a mapping of the one or more sensing nodes to the sensor group corresponds to a mapping of the one or more sensing nodes to logical sensor; a mapping of the one or more sensor groups to the one or more sensing nodes is different than a mapping of the one or more logical sensors to the one or more sensing nodes; the processor is configured to cause the apparatus to generate the configuration information to include one or more of a RAT-independent measurement request or a RAT-dependent sensing measurement type; the processor is configured to cause the apparatus to transmit, to at least one of the one or more sensing nodes or a sensor group associated with the one or more sensing nodes, a request for one or more of RAT-dependent sensing capability information or RAT-independent sensing capability information.

Further, in some implementations, the sensing capability information includes one or more of: a sensing activation latency; a sensing information refresh rate including a minimum time that one or more of a sensing measurement or sensing information is one or more of repeatable or refreshable; a sensing reporting latency; a type of supported or available RAT-independent sensing; a supported sensing information type via RAT-independent sensing; a type of supported or available RAT-dependent sensing; a supported sensing information type via RAT-dependent sensing; one or more of a supported sensing information resolution or a supported sensing information accuracy; one or more of a supported absolute area of sensing or a supported relative area of sensing; or a state of the one or more sensing nodes associated to a sensing capability.

Further, in some implementations, the sensing capability information includes a first sensing capability for a first indicated sensing area and a second sensing capability for a second indicated sensing area; one or more of the first indicated sensing area or the second indicated sensing area includes at least one of an area of interest of sensing or an angular area for sensing; a first sensing capability is indicated for a first sensing node state and a second sensing capability is indicated for a second sensing node state; the sensing capability information is indicated via an index from a codebook, and wherein the codebook includes defined sensing capability characteristics of a sensing node; the apparatus includes a sensing management device that includes one or more of a user equipment (UE), a core network entity, a RAN, a gNB, or a dedicated computation node; the processor is configured to cause the apparatus to receive, from the one or more sensing nodes, a sensing report including sensing measurements associated with one or more of the one or more sensing nodes or a sensing measurement type.

Further, in some implementations, the configuration information includes a measurement configuration for a RAT-dependent sensing measurement associated with the one or more sensing nodes, and the measurement configuration for the RAT-dependent sensing measurement includes one or more of an indication of sensing or a sensing information type; the indication of the sensing information type includes an indication that a configured reference signal received power (RSRP) measurement of an indicated receive beam is intended for environment sensing for detection of an object blockage; the processor is configured to cause the apparatus to receive, from the one or more sensing nodes, an indication of non-RAT dependent sensing information related to configured RAT-dependent sensing measurement; the indication of non-RAT dependent sensing information includes an indication that for one or more of a reference signal received power (RSRP) measurement of a beam directed at a given angle or a doppler measurement of a path, a RAT-independent sensing information is available.

Further, in some implementations, the RAT-independent sensing information includes an observation of one or more of an object blockage or a movement velocity via a camera at a same angle; the processor is configured to cause the apparatus to receive from the one or more sensing nodes an indication of a capability of obtaining a non-RAT dependent sensing information at the one or more sensing nodes related to the configured RAT dependent sensing measurement; the processor is configured to cause the apparatus to receive, from the one or more sensing nodes, an indication indicating that for the RSRP measurement for the beam directed at a given angle or a doppler measurement of a path, a RAT-independent sensing information is available upon network request following the capability information indicated by the one or more sensing nodes; the processor is configured to cause the apparatus to receive, from the one or more sensing nodes, one or more of a non-RAT dependent sensing information or a non-RAT dependent sensing measurement related to the measurement configuration.

Further, in some implementations, the processor is configured to cause the apparatus to receive an indication from the one or more sensing nodes corresponding to a sensing technology utilized for a reported measurement; the processor is configured to cause the apparatus to receive a report indicating a blockage an angle detected based one or more of a WiFi signal or a camera; the processor is configured to cause the apparatus to transmit, to the one or more sensing nodes, a sensing information request, the sensing information request including: an indication of one or more types of sensing information; an indication of at least one of one or more types of RAT-dependent sensor technologies or one or more types of non-RAT dependent sensor technologies to be associated with the sensing information request; and timing information for the sensing information request; the sensing information request is associated with a RAT-independent sensor technology at a sensor device and is based at least in part on the sensing capability information including radio access technology (RAT)-dependent sensing capability information and RAT-independent sensing capability information.

In a further example, the processor 1304 and/or the transceiver 1308 may support wireless communication at the device 1302 in accordance with examples as disclosed herein. The processor 1304 and/or the transceiver 1308, for instance, may be configured as or otherwise support a means for receiving, from one or more sensing nodes, sensing capability information including radio access technology (RAT)-dependent sensing capability information and RAT-independent sensing capability information; generating, based at least in part on the sensing capability information, configuration information including one or more of RAT-dependent sensing information or RAT-independent sensing information; and transmitting, to the one or more sensing nodes, the configuration information.

Further, in some implementations, processor 1304 and/or the transceiver 1308, for instance, may be configured as or otherwise support a means for generating the configuration information to include an association of the one or more sensing nodes with at least one of one or more sensor groups or one or more logical sensors; wherein a sensor group of the one or more sensor groups corresponds to a logical sensor of the one or more logical sensors, and wherein a mapping of the one or more sensing nodes to the sensor group corresponds to a mapping of the one or more sensing nodes to logical sensor; wherein a mapping of the one or more sensor groups to the one or more sensing nodes is different than a mapping of the one or more logical sensors to the one or more sensing nodes; further including generating the configuration information to include one or more of a RAT-independent measurement request or a RAT-dependent sensing measurement type; further including transmitting, to at least one of the one or more sensing nodes or a sensor group associated with the one or more sensing nodes, a request for one or more of RAT-dependent sensing capability information or RAT-independent sensing capability information.

Further, in some implementations the sensing capability information includes one or more of: a sensing activation latency; a sensing information refresh rate including a minimum time that one or more of a sensing measurement or sensing information is one or more of repeatable or refreshable; a sensing reporting latency; a type of supported or available RAT-independent sensing; a supported sensing information type via RAT-independent sensing; a type of supported or available RAT-dependent sensing; a supported sensing information type via RAT-dependent sensing; one or more of a supported sensing information resolution or a supported sensing information accuracy; one or more of a supported absolute area of sensing or a supported relative area of sensing; or a state of the one or more sensing nodes associated to a sensing capability; wherein the sensing capability information includes a first sensing capability for a first indicated sensing area and a second sensing capability for a second indicated sensing area; wherein one or more of the first indicated sensing area or the second indicated sensing area includes at least one of an area of interest of sensing or an angular area for sensing.

Further, in some implementations a first sensing capability is indicated for a first sensing node state and a second sensing capability is indicated for a second sensing node state; wherein the sensing capability information is indicated via an index from a codebook, and wherein the codebook includes defined sensing capability characteristics of a sensing node; wherein the method is performed by a sensing management device that includes one or more of a user equipment (UE), a core network entity, a RAN, a gNB, or a dedicated computation node; further including receiving, from the one or more sensing nodes, a sensing report including sensing measurements associated with one or more of the one or more sensing nodes or a sensing measurement type; wherein the configuration information includes a measurement configuration for a RAT-dependent sensing measurement associated with the one or more sensing nodes, and the measurement configuration for the RAT-dependent sensing measurement includes one or more of an indication of sensing or a sensing information type; wherein the indication of the sensing information type includes an indication that a configured reference signal received power (RSRP) measurement of an indicated receive beam is intended for environment sensing for detection of an object blockage.

Further, in some implementations, processor 1304 and/or the transceiver 1308, for instance, may be configured as or otherwise support a means for receiving, from the one or more sensing nodes, an indication of non-RAT dependent sensing information related to configured RAT-dependent sensing measurement; wherein the indication of non-RAT dependent sensing information includes an indication that for one or more of a reference signal received power (RSRP) measurement of a beam directed at a given angle or a doppler measurement of a path, a RAT-independent sensing information is available; wherein the RAT-independent sensing information includes an observation of one or more of an object blockage or a movement velocity via a camera at a same angle; further including receiving from the one or more sensing nodes an indication of a capability of obtaining a non-RAT dependent sensing information at the one or more sensing nodes related to the configured RAT dependent sensing measurement.

Further, in some implementations, processor 1304 and/or the transceiver 1308, for instance, may be configured as or otherwise support a means for receiving, from the one or more sensing nodes, an indication indicating that for the RSRP measurement for the beam directed at a given angle or a doppler measurement of a path, a RAT-independent sensing information is available upon network request following the capability information indicated by the one or more sensing nodes; further including receiving, from the one or more sensing nodes, one or more of a non-RAT dependent sensing information or a non-RAT dependent sensing measurement related to the measurement configuration; further including receiving an indication from the one or more sensing nodes corresponding to a sensing technology utilized for a reported measurement.

Further, in some implementations, processor 1304 and/or the transceiver 1308, for instance, may be configured as or otherwise support a means for receiving a report indicating a blockage an angle detected based one or more of a WiFi signal or a camera; further including transmitting, to the one or more sensing nodes, a sensing information request, the sensing information request including: an indication of one or more types of sensing information; an indication of at least one of one or more types of RAT-dependent sensor technologies or one or more types of non-RAT dependent sensor technologies to be associated with the sensing information request; and timing information for the sensing information request; wherein the sensing information request is associated with a RAT-independent sensor technology at a sensor device and is based at least in part on the sensing capability information including radio access technology (RAT)-dependent sensing capability information and RAT-independent sensing capability information.

The processor 1304 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1304 may be configured to operate a memory array using a memory controller. In some other implementations, a memory controller may be integrated into the processor 1304. The processor 1304 may be configured to execute computer-readable instructions stored in a memory (e.g., the memory 1306) to cause the device 1302 to perform various functions of the present disclosure.

The memory 1306 may include random access memory (RAM) and read-only memory (ROM). The memory 1306 may store computer-readable, computer-executable code including instructions that, when executed by the processor 1304 cause the device 1302 to perform various functions described herein. The code may be stored in a non-transitory computer-readable medium such as system memory or another type of memory. In some implementations, the code may not be directly executable by the processor 1304 but may cause a computer (e.g., when compiled and executed) to perform functions described herein. In some implementations, the memory 1306 may include, among other things, a basic I/O system (BIOS) which may control basic hardware or software operation such as the interaction with peripheral components or devices.

The I/O controller 1310 may manage input and output signals for the device 1302. The I/O controller 1310 may also manage peripherals not integrated into the device M02. In some implementations, the I/O controller 1310 may represent a physical connection or port to an external peripheral. In some implementations, the I/O controller 1310 may utilize an operating system such as iOS®, ANDROID®, MS-DOS®, MS-WINDOWS®, OS/2®, UNIX®, LINUX®, or another known operating system. In some implementations, the I/O controller 1310 may be implemented as part of a processor, such as the processor M06. In some implementations, a user may interact with the device 1302 via the I/O controller 1310 or via hardware components controlled by the I/O controller 1310.

In some implementations, the device 1302 may include a single antenna 1312. However, in some other implementations, the device 1302 may have more than one antenna 1312 (e.g., multiple antennas), including multiple antenna panels or antenna arrays, which may be capable of concurrently transmitting or receiving multiple wireless transmissions. The transceiver 1308 may communicate bi-directionally, via the one or more antennas 1312, wired, or wireless links as described herein. For example, the transceiver 1308 may represent a wireless transceiver and may communicate bi-directionally with another wireless transceiver. The transceiver 1308 may also include a modem to modulate the packets, to provide the modulated packets to one or more antennas 1312 for transmission, and to demodulate packets received from the one or more antennas 1312.

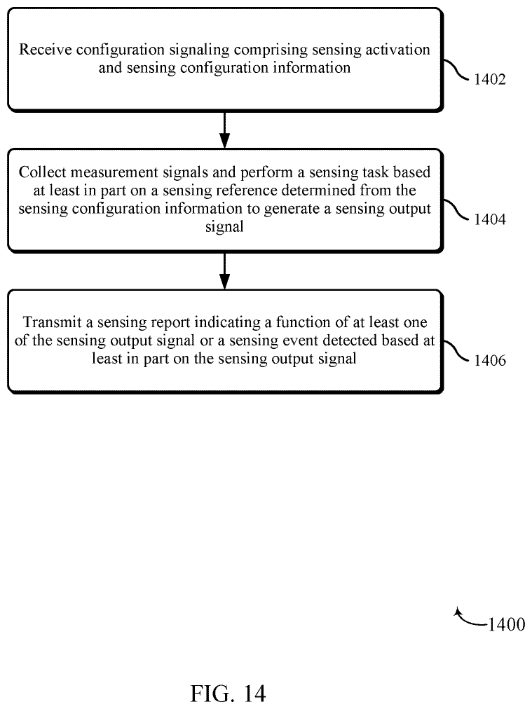

FIG. 14 illustrates a flowchart of a method 1400 that supports sensor network capability determination in accordance with aspects of the present disclosure. The operations of the method 1400 may be implemented by a device or its components as described herein. For example, the operations of the method 1400 may be performed by a sensing node (e.g., a UE 104) as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1402, the method may include receiving configuration signaling comprising sensing activation and sensing configuration information. The operations of 1402 may be performed in accordance with examples as described herein. In some implementations, aspects of the operations of 1402 may be performed by a device as described with reference to FIG. 1.

At 1404, the method may include collecting measurement signals and perform a sensing task based at least in part on a sensing reference determined from the sensing configuration information to generate a sensing output signal. The operations of 1404 may be performed in accordance with examples as described herein. In some implementations, aspects of the operations of 1404 may be performed by a device as described with reference to FIG. 1.

At 1406, the method may include transmitting a sensing report indicating a function of at least one of the sensing output signal or a sensing event detected based at least in part on the sensing output signal. The operations of 1406 may be performed in accordance with examples as described herein. In some implementations, aspects of the operations of 1406 may be performed by a device as described with reference to FIG. 1.

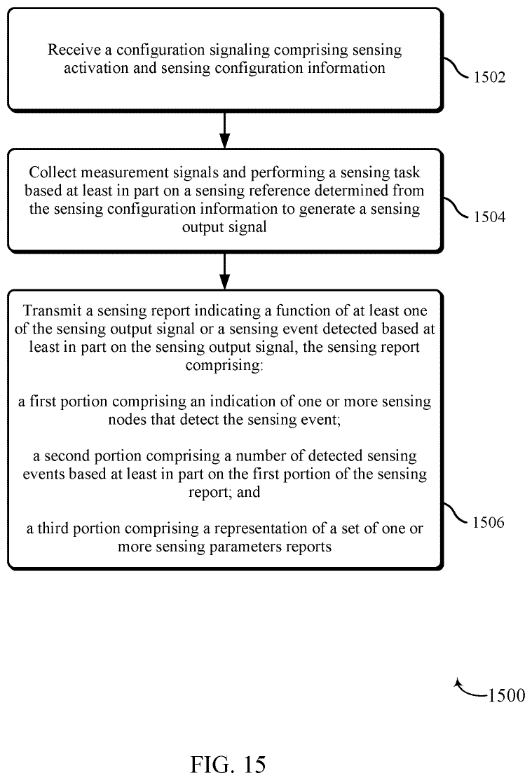

FIG. 15 illustrates a flowchart of a method 1500 that supports sensor network capability determination in accordance with aspects of the present disclosure. The operations of the method 1500 may be implemented by a device or its components as described herein. For example, the operations of the method 1500 may be performed by a sensing node (e.g., a UE 104) as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1502, the method may include receiving a configuration signaling comprising sensing activation and sensing configuration information. The operations of 1502 may be performed in accordance with examples as described herein. In some implementations, aspects of the operations of 1502 may be performed by a device as described with reference to FIG. 1.

At 1504, the method may include collecting measurement signals and performing a sensing task based at least in part on a sensing reference determined from the sensing configuration information to generate a sensing output signal. The operations of 1504 may be performed in accordance with examples as described herein. In some implementations, aspects of the operations of 1504 may be performed by a device as described with reference to FIG. 1.

At 1506, the method may include transmitting a sensing report indicating a function of at least one of the sensing output signal or a sensing event detected based at least in part on the sensing output signal, the sensing report comprising: a first portion comprising an indication of one or more sensing nodes that detect the sensing event; a second portion comprising a number of detected sensing events based at least in part on the first portion of the sensing report; and a third portion comprising a representation of a set of one or more sensing parameters reports. The operations of 1506 may be performed in accordance with examples as described herein. In some implementations, aspects of the operations of 1506 may be performed by a device as described with reference to FIG. 1.

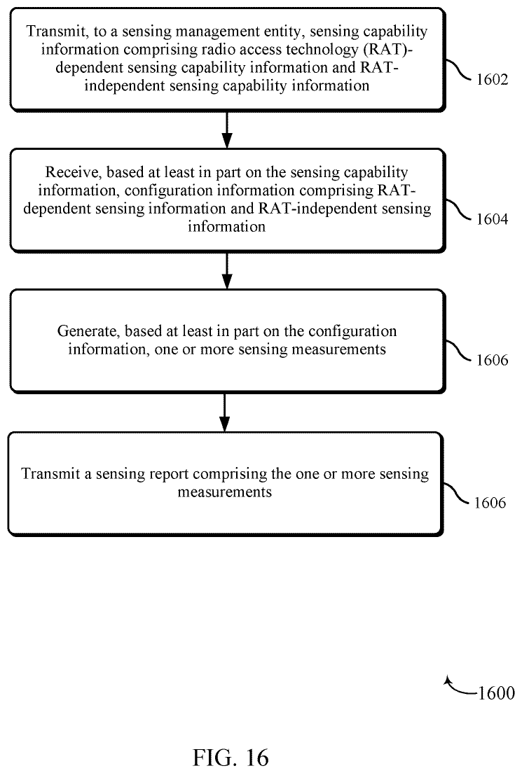

FIG. 16 illustrates a flowchart of a method 1600 that supports sensor network capability determination in accordance with aspects of the present disclosure. The operations of the method 1600 may be implemented by a device or its components as described herein. For example, the operations of the method 1600 may be performed by a sensing node (e.g., a UE 104) as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1602, the method may include transmitting, to a sensing management entity, sensing capability information comprising radio access technology (RAT)-dependent sensing capability information and RAT-independent sensing capability information. The operations of 1602 may be performed in accordance with examples as described herein. In some implementations, aspects of the operations of 1602 may be performed by a device as described with reference to FIG. 1.

At 1604, the method may include receiving, based at least in part on the sensing capability information, configuration information comprising RAT-dependent sensing information and RAT-independent sensing information. The operations of 1604 may be performed in accordance with examples as described herein. In some implementations, aspects of the operations of 1604 may be performed by a device as described with reference to FIG. 1.

At 1606, the method may include generating, based at least in part on the configuration information, one or more sensing measurements. The operations of 1606 may be performed in accordance with examples as described herein. In some implementations, aspects of the operations of 1606 may be performed by a device as described with reference to FIG. 1.

At 1608, the method may include transmitting a sensing report comprising the one or more sensing measurements. The operations of 1608 may be performed in accordance with examples as described herein. In some implementations, aspects of the operations of 1608 may be performed by a device as described with reference to FIG. 1.

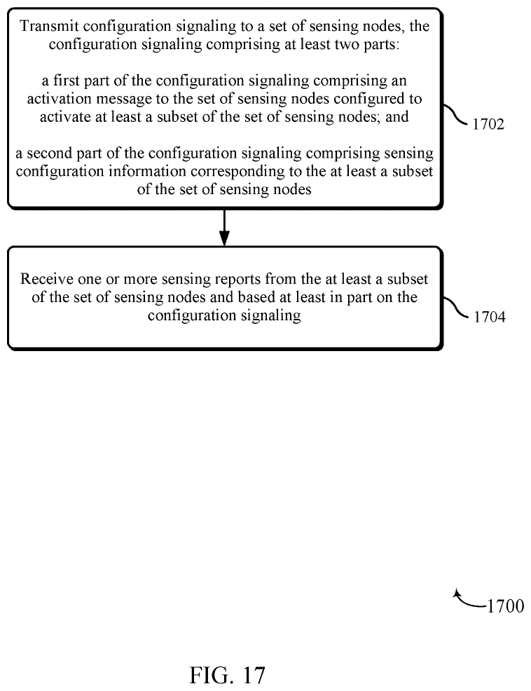

FIG. 17 illustrates a flowchart of a method 1700 that supports sensor network capability determination in accordance with aspects of the present disclosure. The operations of the method 1700 may be implemented by a device or its components as described herein. For example, the operations of the method 1700 may be performed by a sensing configuration entity (e.g., a network entity 102) such as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1702, the method may include transmitting configuration signaling to a set of sensing nodes, the configuration signaling comprising at least two parts: a first part of the configuration signaling comprising an activation message to the set of sensing nodes configured to activate at least a subset of the set of sensing nodes; and a second part of the configuration signaling comprising sensing configuration information corresponding to the at least a subset of the set of sensing nodes. The operations of 1702 may be performed in accordance with examples as described herein. In some implementations, aspects of the operations of 1702 may be performed by a device as described with reference to FIG. 1.

At 1704, the method may include receiving one or more sensing reports from the at least a subset of the set of sensing nodes and based at least in part on the configuration signaling. The operations of 1704 may be performed in accordance with examples as described herein. In some implementations, aspects of the operations of 1704 may be performed by a device as described with reference to FIG. 1.

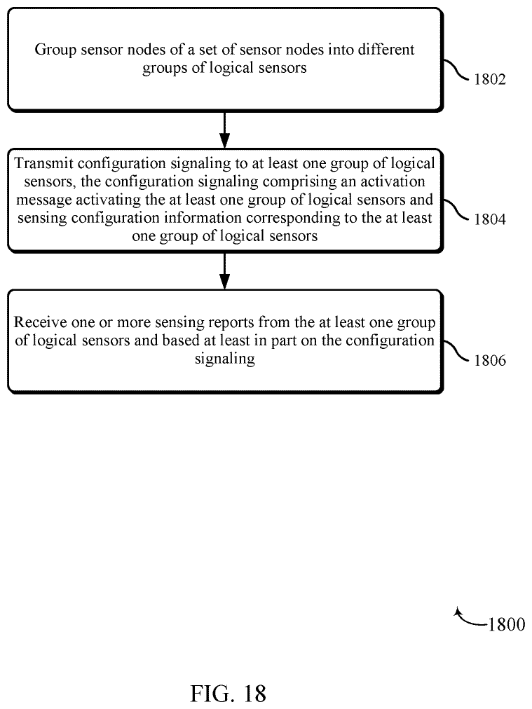

FIG. 18 illustrates a flowchart of a method 1800 that supports sensor network capability determination in accordance with aspects of the present disclosure. The operations of the method 1800 may be implemented by a device or its components as described herein. For example, the operations of the method 1800 may be performed by a sensing configuration entity (e.g., a network entity 102) such as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1802, the method may include grouping sensor nodes of a set of sensor nodes into different groups of logical sensors. The operations of 1802 may be performed in accordance with examples as described herein. In some implementations, aspects of the operations of 1802 may be performed by a device as described with reference to FIG. 1.

At 1804, the method may include transmitting configuration signaling to at least one group of logical sensors, the configuration signaling comprising an activation message activating the at least one group of logical sensors and sensing configuration information corresponding to the at least one group of logical sensors. The operations of 1804 may be performed in accordance with examples as described herein. In some implementations, aspects of the operations of 1804 may be performed by a device as described with reference to FIG. 1.

At 1806, the method may include receiving one or more sensing reports from the at least one group of logical sensors and based at least in part on the configuration signaling. The operations of 1806 may be performed in accordance with examples as described herein. In some implementations, aspects of the operations of 1806 may be performed by a device as described with reference to FIG. 1.

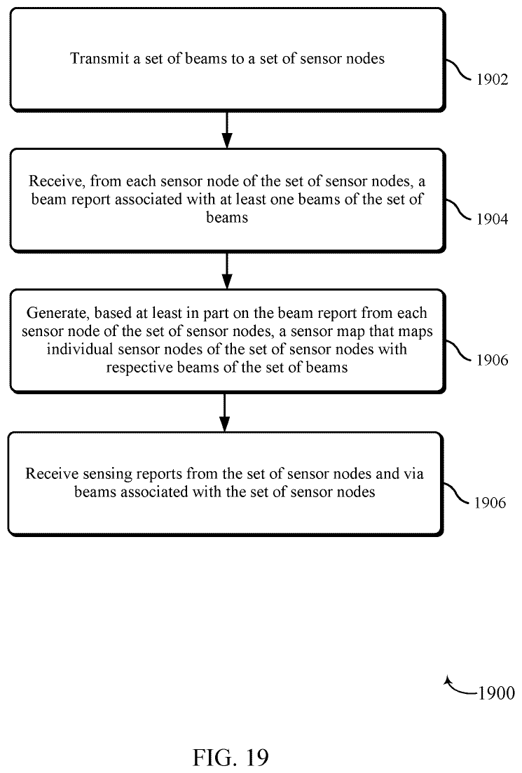

FIG. 19 illustrates a flowchart of a method 1900 that supports sensor network capability determination in accordance with aspects of the present disclosure. The operations of the method 1900 may be implemented by a device or its components as described herein. For example, the operations of the method 1900 may be performed by a sensing configuration entity (e.g., a network entity 102) such as described with reference to FIGS. 1 through 13. In some implementations, the device may execute a set of instructions to control the function elements of the device to perform the described functions. Additionally, or alternatively, the device may perform aspects of the described functions using special-purpose hardware.

At 1902, the method may include transmitting a set of beams to a set of sensor nodes. The operations of 1902 may be performed in accordance with examples as described herein. In some implementations, aspects of the operations of 1902 may be performed by a device as described with reference to FIG. 1.

At 1904, the method may include receiving, from each sensor node of the set of sensor nodes, a beam report associated with at least one beams of the set of beams. The operations of 1904 may be performed in accordance with examples as described herein. In some implementations, aspects of the operations of 1904 may be performed by a device as described with reference to FIG. 1.

At 1906, the method may include generating, based at least in part on the beam report from each sensor node of the set of sensor nodes, a sensor map that maps individual sensor nodes of the set of sensor nodes with respective beams of the set of beams. The operations of 1906 may be performed in accordance with examples as described herein. In some implementations, aspects of the operations of 1906 may be performed by a device as described with reference to FIG. 1.

At 1908, the method may include receiving sensing reports from the set of sensor nodes and via beams associated with the set of sensor nodes. The operations of 1908 may be performed in accordance with examples as described herein. In some implementations, aspects of the operations of 1908 may be performed by a device as described with reference to FIG. 1.

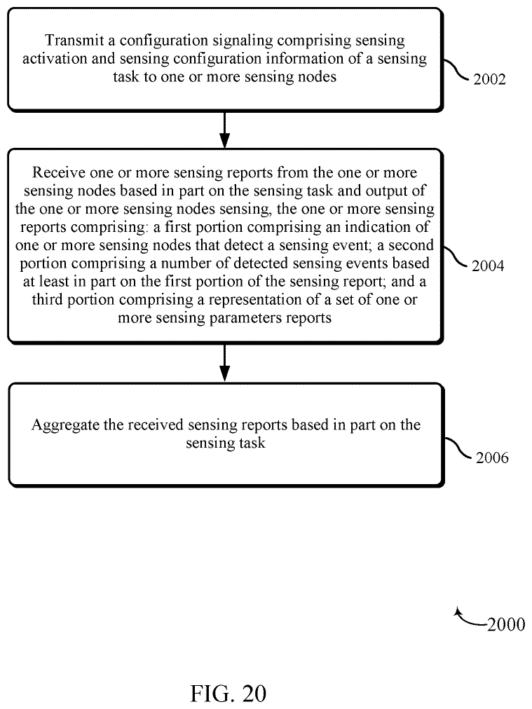

FIG. 20 illustrates a flowchart of a method 2000 that supports sensor network capability determination in accordance with aspects of the present disclosure. The operations of the method 2000 may be implemented by a device or its components as described herein. For example, the operations of the method 2000 may be performed by a sensing configuration entity (e.g., a network entity 102) such as described with reference to FIGS. 1 through 13. In some implementations, the device may execute a set of instructions to control the function elements of the device to perform the described functions. Additionally, or alternatively, the device may perform aspects of the described functions using special-purpose hardware.

At 2002, the method may include transmitting a configuration signaling comprising sensing activation and sensing configuration information of a sensing task to one or more sensing nodes. The operations of 2002 may be performed in accordance with examples as described herein. In some implementations, aspects of the operations of 2002 may be performed by a device as described with reference to FIG. 1.

At 2004, the method may include receiving one or more sensing reports from the one or more sensing nodes based in part on the sensing task and output of the one or more sensing nodes sensing, the one or more sensing reports comprising: a first portion comprising an indication of one or more sensing nodes that detect a sensing event; a second portion comprising a number of detected sensing events based at least in part on the first portion of the sensing report; and a third portion comprising a representation of a set of one or more sensing parameters reports. The operations of 2004 may be performed in accordance with examples as described herein. In some implementations, aspects of the operations of 2004 may be performed by a device as described with reference to FIG. 1.

At 2006, the method may include aggregating the received sensing reports based in part on the sensing task. The operations of 2006 may be performed in accordance with examples as described herein. In some implementations, aspects of the operations of 2006 may be performed by a device as described with reference to FIG. 1.

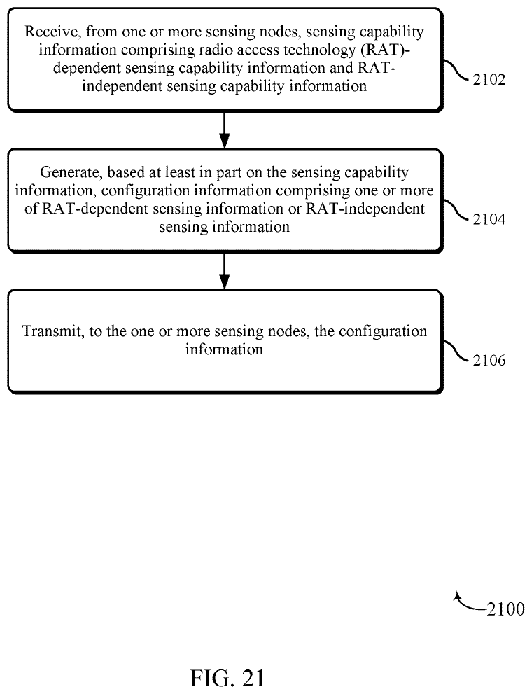

FIG. 21 illustrates a flowchart of a method 2100 that supports sensor network capability determination in accordance with aspects of the present disclosure. The operations of the method 2100 may be implemented by a device or its components as described herein. For example, the operations of the method 2100 may be performed by a sensing configuration entity (e.g., a network entity 102) such as described with reference to FIGS. 1 through 13. In some implementations, the device may execute a set of instructions to control the function elements of the device to perform the described functions. Additionally, or alternatively, the device may perform aspects of the described functions using special-purpose hardware.

At 2102, the method may include receiving, from one or more sensing nodes, sensing capability information comprising radio access technology (RAT)-dependent sensing capability information and RAT-independent sensing capability information. The operations of 2102 may be performed in accordance with examples as described herein. In some implementations, aspects of the operations of 2102 may be performed by a device as described with reference to FIG. 1.

At 2104, the method may include generating, based at least in part on the sensing capability information, configuration information comprising one or more of RAT-dependent sensing information or RAT-independent sensing information. The operations of 2104 may be performed in accordance with examples as described herein. In some implementations, aspects of the operations of 2104 may be performed by a device as described with reference to FIG. 1.

At 2106, the method may include transmitting, to the one or more sensing nodes, the configuration information. The operations of 2106 may be performed in accordance with examples as described herein. In some implementations, aspects of the operations of 2106 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication, comprising:
at least one memory; and
at least one processor coupled with the at least one memory and operable to cause the apparatus to:
receive, from one or more sensing nodes, sensing capability information comprising radio access technology (RAT)-dependent sensing capability information and RAT-independent sensing capability information;
generate, based at least in part on the sensing capability information, configuration information comprising one or more of RAT-dependent sensing information or RAT-independent sensing information; and
transmit, to the one or more sensing nodes, the configuration information.

2. The apparatus of claim 1, wherein the at least one processor is operable to cause the apparatus to generate the configuration information to comprise an association of the one or more sensing nodes with at least one of one or more sensor groups or one or more logical sensors.

3. The apparatus of claim 2, wherein a sensor group of the one or more sensor groups corresponds to a logical sensor of the one or more logical sensors, and wherein a mapping of the one or more sensing nodes to the sensor group corresponds to a mapping of the one or more sensing nodes to logical sensor.

4. The apparatus of claim 1, wherein the at least one processor is operable to cause the apparatus to generate the configuration information to comprise one or more of a RAT-independent measurement request or a RAT-dependent sensing measurement type.

5. The apparatus of claim 1, wherein the at least one processor is operable to cause the apparatus to transmit, to at least one of the one or more sensing nodes or a sensor group associated with the one or more sensing nodes, a request for one or more of RAT-dependent sensing capability information or RAT-independent sensing capability information.

6. The apparatus of claim 1, wherein the sensing capability information comprises one or more of:
a sensing activation latency;
a sensing information refresh rate comprising a minimum time that one or more of a sensing measurement or sensing information is one or more of repeatable 12 or refreshable;
a sensing reporting latency;
a type of supported or available RAT-independent sensing;
a supported sensing information type via RAT-independent sensing;
a type of supported or available RAT-dependent sensing;
a supported sensing information type via RAT-dependent sensing;
one or more of a supported sensing information resolution or a supported sensing information accuracy;
one or more of a supported absolute area of sensing or a supported relative area of sensing; or
a state of the one or more sensing nodes associated to a sensing capability.

7. The apparatus of claim 1, wherein the sensing capability information comprises a first sensing capability for a first indicated sensing area and a second sensing capability for a second indicated sensing area.

8. The apparatus of claim 1, wherein the sensing capability information is indicated via an index from a codebook, and wherein the codebook comprises defined sensing capability characteristics of a sensing node.

9. The apparatus of claim 1, wherein the apparatus comprises a sensing management device that comprises one or more of a user equipment (UE), a core network entity, a radio access network (RAN), a next-generation NodeB (gNB), or a dedicated computation node.

10. The apparatus of claim 1, wherein the at least one processor is operable to cause the apparatus to receive, from the one or more sensing nodes, a sensing report comprising sensing measurements associated with one or more of the one or more sensing nodes or a sensing measurement type.

11. The apparatus of claim 1, wherein the configuration information comprises a measurement configuration for a RAT-dependent sensing measurement associated with the one or more sensing nodes, and the measurement configuration for the RAT-dependent sensing measurement comprises one or more of an indication of sensing or a sensing information type.

12. The apparatus of claim 11, wherein the indication of the sensing information type comprises an indication that a configured reference signal received power (RSRP) measurement of an indicated receive beam is intended for environment sensing for detection of an object blockage.

13. The apparatus of claim 11, wherein the at least one processor is operable to cause the apparatus to receive, from the one or more sensing nodes, an indication of non-RAT dependent sensing information related to configured RAT-dependent sensing measurement.

14. The apparatus of claim 13, wherein the indication of non-RAT dependent sensing information comprises an indication that for one or more of a reference signal received power (RSRP) measurement of a beam directed at a given angle or a doppler measurement of a path, a RAT-independent sensing information is available.

15. The apparatus of claim 14, wherein the RAT-independent sensing information comprises an observation of one or more of an object blockage or a movement velocity via a camera at a same angle.

16. The apparatus of claim 11, wherein the at least one processor is operable to cause the apparatus to receive from the one or more sensing nodes an indication of a capability of obtaining a non-RAT dependent sensing information at the one or more sensing nodes related to a configured RAT dependent sensing measurement.

17. The apparatus of claim 16, wherein the at least one processor is operable to cause the apparatus to receive, from the one or more sensing nodes, an indication indicating that for a reference signal received power (RSRP) measurement for a beam directed at a given angle or a doppler measurement of a path, a RAT-independent sensing information is available upon network request following the capability information indicated by the one or more sensing nodes.

18. (canceled)

19. An apparatus for wireless communication, comprising:
a processor; and
a memory coupled to the processor, the processor operable to cause the apparatus to:
transmit, to a sensing management entity, sensing capability information comprising radio access technology (RAT)-dependent sensing capability information and RAT-independent sensing capability information;
receive, based at least in part on the sensing capability information, configuration information comprising RAT-dependent sensing information and RAT-independent sensing information;
generate, based at least in part on the configuration information, one or more sensing measurements; and
transmit a sensing report comprising the one or more sensing measurements.

20. A method performed by an apparatus, the method comprising:
receiving, from one or more sensing nodes, sensing capability information comprising radio access technology (RAT)-dependent sensing capability 18 information and RAT-independent sensing capability information;
generating, based at least in part on the sensing capability information, configuration information comprising one or more of RAT-dependent sensing information or RAT-independent sensing information; and
transmitting, to the one or more sensing nodes, the configuration information.

21. A method performed by an apparatus, the method comprising:
transmitting, to a sensing management entity, sensing capability information comprising radio access technology (RAT)-dependent sensing capability information and RAT-independent sensing capability information;
receiving, based at least in part on the sensing capability information, configuration information comprising RAT-dependent sensing information and RAT-independent sensing information;
generating, based at least in part on the configuration information, one or more sensing measurements; and
transmitting a sensing report comprising the one or more sensing measurements.
